(19) United States
(12) Patent Application Publication
(10) Pub. No.: US 2026/0057823 A1
(43) Pub. Date: Feb. 26, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: DONG HEE SHIN, YONGIN-SI (KR); DOYEONG PARK, YONGIN-SI (KR)

(21) Appl. No.: 19/206,562

(22) Filed: May 13, 2025

(30) Foreign Application Priority Data
Aug. 21, 2024 (KR) 10-2024-0112098

(51) Int. Cl. G09G 3/32; G09G 3/3233

(52) U.S. Cl. CPC G09G 3/32; G09G 3/3233; G09G 2300/0819; G09G 2360/142

(57) ABSTRACT

A display device includes: a pixel driving circuit portion located on a substrate, a sensor driving circuit portion located on the pixel driving circuit portion, a light-emitting element electrically connected to the pixel driving circuit portion, and a light-receiving element electrically connected to the sensor driving circuit portion. Accordingly, a sufficient space in which the pixel driving circuit portion and the sensor driving circuit portion are located may be secured, and a circuit layer suitable for a high-resolution display device may be provided.

### CROSS-REFERENCE TO RELATED APPLICATION(S)

This application claims priority under 35 U.S.C. § 119 to Korean Patent Application No. 10-2024-0112098, filed on Aug. 21, 2024, in the Korean Intellectual Property Office (KIPO), the entire disclosure of which is incorporated by reference herein.

### FIELD

The present disclosure generally relates to a display device and an electronic device including the same, and particularly relates to a display device providing visual information and an electronic device including the same.

### INTRODUCTION

A display device is a device that displays an image for providing visual information to a user. Among display devices, an organic light-emitting diode (OLED) type of display device is but one example.

A display device may include a function for sensing a user's biometric information. The display device may detect the user's biometric information through a capacitive method for sensing a change in capacitance formed between electrodes, an optical method for sensing light using a sensor, an ultrasonic method for sensing vibration using a piezoelectric material, or the like.

### SUMMARY

Embodiments of the present disclosure may provide a display device with optimized display quality.

For example, an embodiment may provide an electronic device including the display device.

A display device according to an embodiment includes a pixel driving circuit portion located on a substrate, a sensor driving circuit portion located on the pixel driving circuit portion, a light-emitting element electrically connected to the pixel driving circuit portion, and a light-receiving element electrically connected to the sensor driving circuit portion.

In an embodiment, the sensor driving circuit portion and the pixel driving circuit portion may at least partially overlap each other in a plan view.

In an embodiment, the pixel driving circuit portion may include a plurality of transistors, and the sensor driving circuit portion may include a plurality of sensor transistors located on the plurality of transistors.

In an embodiment, substantially all transistors included in the sensor driving circuit portion may be located on transistors included in the pixel driving circuit portion.

In an embodiment, the display device may further include a voltage line electrically connected to each of the pixel driving circuit portion and the sensor driving circuit portion.

In an embodiment, the voltage line may apply an initialization voltage to each of the pixel driving circuit portion and the sensor driving circuit portion.

A display device according to an embodiment includes a plurality of first unit light-emitting areas located along a first direction, a plurality of second unit light-emitting areas located along the first direction and spaced apart from the plurality of first unit light-emitting areas in a second direction crossing the first direction, a light-receiving area located in at least a portion between the plurality of first unit light-emitting areas and the plurality of second unit light-emitting areas, and a hole area located in at least a portion between the plurality of first unit light-emitting areas and the plurality of second unit light-emitting areas and spaced apart from the light-receiving area in a plan view.

In an embodiment, a light-receiving element may be located in the light-receiving area.

In an embodiment, a contact portion where a first sub-electrode and a second sub-electrode contact each other may be located in the hole area.

In an embodiment, the first sub-electrode may contact a voltage pattern to which a power voltage is applied in the hole area.

In an embodiment, the light-receiving area may at least partially overlap the hole area in the first direction.

In an embodiment, each of the plurality of first unit light-emitting areas may include a first light-emitting area emitting a first light, a second light-emitting area emitting a second light, and a third light-emitting area emitting a third light, each of the plurality of second unit light-emitting areas may include a fourth light-emitting area emitting the first light, a fifth light-emitting area emitting the second light, and a sixth light-emitting area emitting the third light, the light-receiving area may be located between one of the plurality of third light-emitting areas and one of the plurality of sixth light-emitting areas, and the hole area may be located between another one of the plurality of third light-emitting areas and another one of the plurality of sixth light-emitting areas.

In an embodiment, a distance between the light-receiving area and the one of the plurality of third light-emitting areas adjacent to the light-receiving area and a distance between the hole area and the other one of the plurality of third light-emitting areas adjacent to the hole area may be substantially the same.

In an embodiment, the plurality of first unit light-emitting areas and the plurality of second unit light-emitting areas may be alternately located along the second direction.

In an embodiment, the light-receiving area may at least partially overlap the hole area in the second direction.

In an embodiment, each of the plurality of first unit light-emitting areas may include a first light-emitting area emitting a first light, a second light-emitting area emitting a second light, and a third light-emitting area emitting a third light, each of the plurality of second unit light-emitting areas may include a fourth light-emitting area emitting the first light, a fifth light-emitting area emitting the second light, and a sixth light-emitting area emitting the third light, and a relative position of the third light-emitting area with respect to the first light-emitting area and a relative position of the sixth light-emitting area with respect to the fourth light-emitting area may be different from each other.

In an embodiment, the light-receiving area may include a plurality of light-receiving areas having a substantially constant separation distance from each other.

In an embodiment, each of the first and second unit light-emitting areas may include a first light-emitting area emitting a first color of light, a second light-emitting area emitting a second color of light, and a third light-emitting area emitting a third color of light, and a distance between the light-receiving area and a third light-emitting area nearest adjacent to the light-receiving area and a distance between the hole area and a third light-emitting area nearest adjacent to the hole area may be substantially the same.

A display device according to an embodiment includes unit light-emitting areas repeatedly located along a first direction and a second direction crossing the first direction, a light-receiving area located between at least a portion of the adjacent unit light-emitting areas of the unit light-emitting areas, and a hole area located between at least a portion of the adjacent unit light-emitting areas of the unit light-emitting areas and spaced apart from the light-receiving area.

In an embodiment, a light-receiving element may be located in the light-receiving area.

In an embodiment, a contact portion where a first sub-electrode and a second sub-electrode contact each other may be located in the hole area.

In an embodiment, the first sub-electrode may contact a voltage pattern to which a power voltage is applied in the hole area.

In an embodiment, the light-receiving area may at least partially overlap the hole area in the first direction.

In an embodiment, the light-receiving area may include a plurality of light-receiving areas having a constant separation distance from each other.

In an embodiment, each of the unit light-emitting areas may include a first light-emitting area emitting a first light, a second light-emitting area emitting a second light, and a third light-emitting area emitting a third light, and a distance between the light-receiving area and the third light-emitting area adjacent to the light-receiving area and a distance between the hole area and the third light-emitting area adjacent to the hole area may be substantially the same.

An electronic device according to an embodiment includes a pixel driving circuit portion located on a substrate, a sensor driving circuit portion located on the pixel driving circuit portion, a light-emitting element electrically connected to the pixel driving circuit portion, a light-receiving element electrically connected to the sensor driving circuit portion, and a memory configured to store at least one of pixel data information for the light-emitting element or sensor data information from the light-receiving element.

In an embodiment, the sensor driving circuit portion and the pixel driving circuit portion may at least partially overlap each other in a plan view.

In an embodiment, the pixel driving circuit portion may include a plurality of pixel transistors, and the sensor driving circuit portion may include a plurality of sensor transistors located on the plurality of pixel transistors.

In an embodiment, substantially all sensor transistors included in the sensor driving circuit portion may be located on pixel transistors included in the pixel driving circuit portion.

In an embodiment, the electronic device includes: a plurality of unit light-emitting areas repeatedly located along a first direction and a second direction crossing the first direction, each unit light-emitting area comprising a plurality of light-emitting elements, a plurality of light-receiving areas repeatedly located between at least some pairs of substantially adjacent unit light-emitting areas, each light-receiving area comprising at least one light-receiving element, a plurality of hole areas located between at least other pairs of substantially adjacent unit light-emitting areas and spaced apart from each of the plurality of light-receiving areas, each hole area comprising a plurality of contact portions in which a first sub-electrode and a second sub-electrode contact each other.

A display device according to an embodiment may include a pixel driving circuit portion located on a substrate, a sensor driving circuit portion located on the pixel driving circuit portion, a light-emitting element electrically connected to the pixel driving circuit portion, and a light-receiving element electrically connected to the sensor driving circuit portion. Accordingly, a sufficient space in which the pixel driving circuit portion and the sensor driving circuit portion are located may be secured. Accordingly, a circuit layer suitable for a high-resolution display device may be provided.

In addition, a display device according to an embodiment may include first unit light-emitting areas located along a first direction, second unit light-emitting areas spaced apart from the first unit light-emitting areas in a second direction crossing the first direction and located along the first direction, light-receiving area located in at least a portion between the first unit light-emitting areas and the second unit light-emitting areas, and a hole area located in at least a portion between the first unit light-emitting areas and the second unit light-emitting areas and spaced apart from the light-receiving area in a plan view. A light-receiving element may be located in the light-receiving area. A contact portion where a first sub-electrode and a second sub-electrode contact each other may be located in the hole area. The light-receiving area may be located in an area in which the hole area is previously located. That is, the light-receiving area may be located by using an area in which the hole area is previously located. Accordingly, a light-receiving area for sensing user's biometric information may be included in the display device without reducing resolution of the display device.

### BRIEF DESCRIPTION OF THE DRAWINGS

Illustrative, non-limiting embodiments will be more clearly understood from the following detailed description when taken in conjunction with the accompanying drawings.

FIG. 1 is a perspective view diagram illustrating a display device according to an embodiment.

FIG. 2 is a cross-sectional view diagram illustrating the display device of FIG. 1.

FIG. 3 is a block diagram illustrating the display device of FIG. 1.

FIG. 4 is a circuit diagram illustrating a pixel and a sensor included in the display device of FIG. 3.

FIG. 5 is an enlarged plan view diagram of a partial area of the display device of FIG. 1.

FIG. 6 is an unfolded cross-sectional view diagram of the display device of FIG. 5 taken along folded cut line I-I′.

FIG. 7 is a cross-sectional view diagram of the display device of FIG. 5 taken along cut line II-II′.

FIG. 8 is an enlarged plan view diagram of a partial area of a display device according to an embodiment.

FIG. 9 is an enlarged plan view diagram of a partial area of a display device according to an embodiment.

FIG. 10 is a block diagram illustrating an electronic device according to an embodiment.

FIG. 11 is a schematic diagram of an electronic device according to an embodiment.

### DETAILED DESCRIPTION

Hereinafter, display devices in accordance with illustrative embodiments will be described by way of example with reference to the accompanying drawings. The same or like reference numerals may be used for the same or like components in the drawings, and redundant descriptions of the same or like components may be omitted.

A display device according to an embodiment may include first unit light-emitting areas located along a first direction, second unit light-emitting areas located along the first direction and spaced apart from the first unit light-emitting areas in a second direction crossing the first direction, a light-receiving area located between the first unit light-emitting areas and the second unit light-emitting areas in a plan view, sensor transistors stacked over pixel transistors in a side view, and a hole area located in between the first unit light-emitting areas and the second unit light-emitting areas and spaced apart from the light-receiving area in a plan view. A light-receiving element may be located in the light-receiving area, and a contact portion where a first sub-electrode and a second sub-electrode contact each other may be located in the hole area. The light-receiving area may be located in an area suitable for the hole area, and may overlap the light-emitting areas in a plan view. Thus, a light-receiving area for sensing a user's biometric information may be included in the display device while maximizing resolution of the display device.

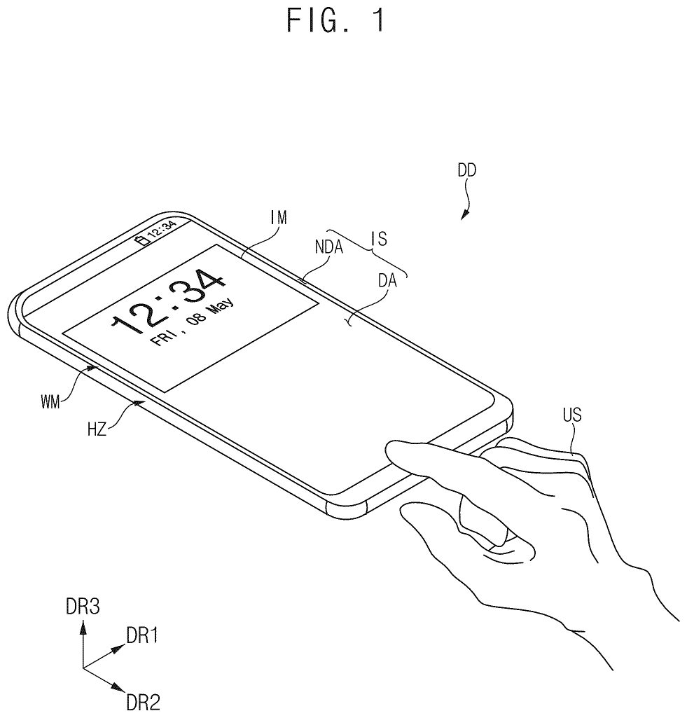

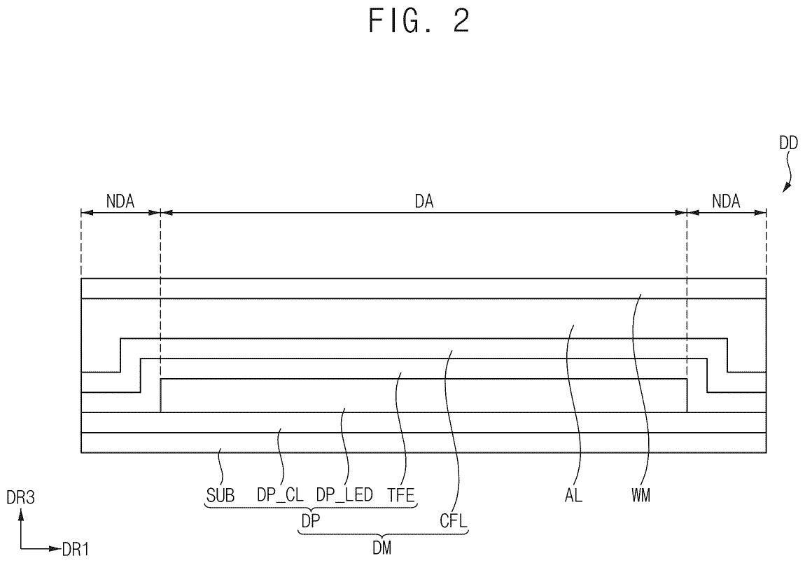

FIG. 1 illustrates a display device according to an embodiment. FIG. 2 further illustrates the display device of FIG. 1.

Referring to FIG. 1, a display device DD according to an embodiment may be a device activated by an electrical signal. For example, the display device DD may be a relatively small display device used in a relatively small electronic device such as a smartphone, mobile phone, smart watch, game console, camera, or the like. However, this disclosure is not limited thereto, and the display device DD may be a relatively medium to large-sized display device used in a relatively medium to large-sized electronic device such as a laptop, tablet, personal computer (PC), television, computer monitor, vehicle monitor, external billboard, or the like.

An upper surface of the display device DD may be defined as a display surface IS. The display surface IS may be a surface parallel to a plane formed by a first direction DR1 and a second direction DR2 crossing the first direction DR1. An image IM generated by the display device DD may be provided to a user through the display surface IS.

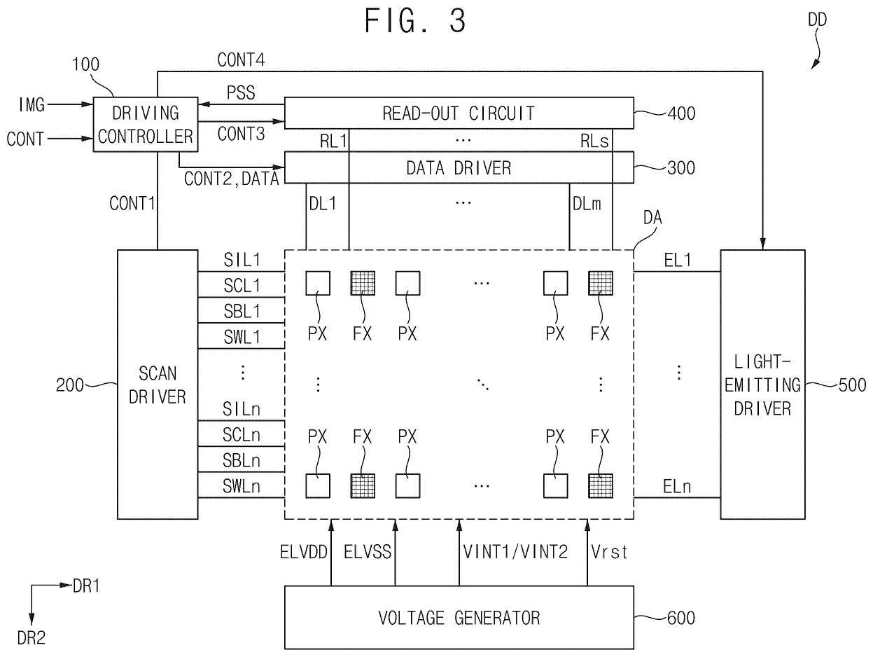

The display device DD may include a display area DA and a non-display area NDA. For example, the display surface IS may be divided into the display area DA and the non-display area NDA. The display area DA may be an area in which the image IM is displayed. For example, the display area DA may be an area for displaying the image IM by generating light and/or adjusting transmittance of light provided from an external light source. The non-display area NDA may surround at least a portion of the display area DA. In an embodiment, the non-display area NDA may be an area in which the image IM is not or need not be displayed. However, this disclosure is not limited thereto, and the image IM may be displayed in a portion of the non-display area NDA. The non-display area NDA may include a plurality of drivers. The plurality of drivers may be described in greater detail, infra, with reference to FIG. 3.

The display device DD may detect an external input provided from an outside source. The external input may include various types of inputs provided from outside of the display device DD. For example, the external input may include contact by a portion of a body such as a user's hand US or contact by an electronic pen such as a stylus pen. In addition, the external input may include various input forms such as force, pressure, temperature, light. and/or the like.

The display device DD may sense a user's biometric information provided from the outside. For example, a biometric information sensing area capable of sensing the user's biometric information may be located on the display surface IS of the display device DD. The biometric information sensing area may be located in at least a portion of the display area DA, without limitation thereto.

The display device DD may include a housing HZ and a window WM. The window WM and the housing HZ may be coupled to each other to constitute an external appearance of the display device DD. The housing HZ may protect components included in the display device DD from external impact. The housing HZ may include a material having relatively high rigidity. For example, the housing HZ may include glass, plastic, metal, and/or the like. These and comparable materials may be used alone or in combination with each other. The window WM may be coupled to the housing HZ. For example, the window WM may be an ultra thin glass or polyimide film, but this disclosure is not limited thereto.

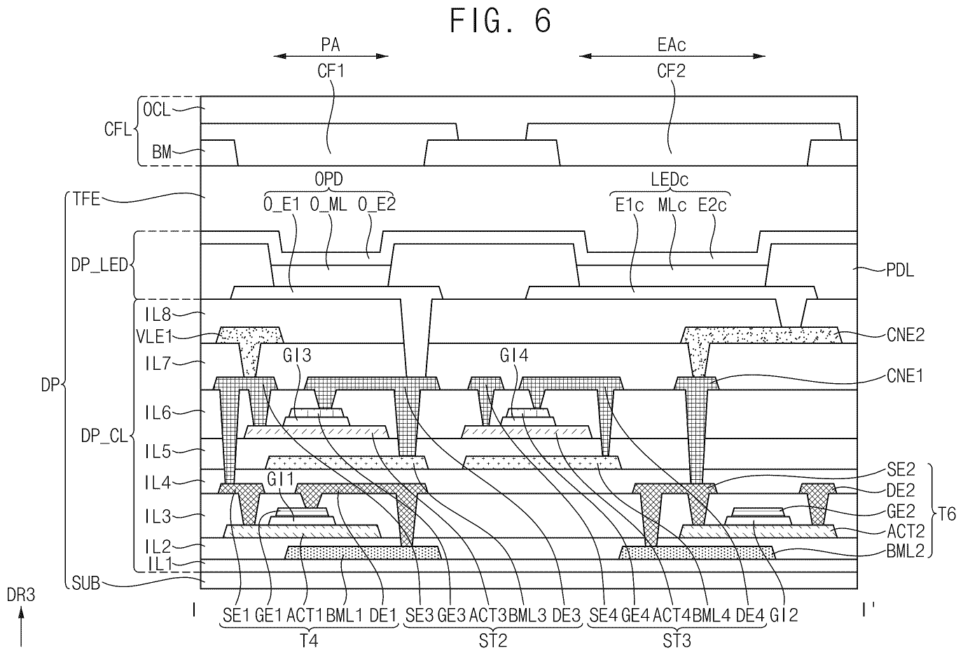

Referring now to FIG. 2, the display device DD may include a display module DM disposed under the window WM. The display module DM may include a display panel DP and a light control layer CFL. The display panel DP may display an image according to an electrical signal. For example, the display panel DP may include a pixel (e.g., a pixel PX of FIG. 3). The light control layer CFL may be located on the display panel DP. The light control layer CFL may include a plurality of color filters and a black matrix (e.g., a black matrix BM of FIG. 6). The window WM may be located on the light control layer CFL.

The display device DD may further include an adhesive layer AL. The window WM may be attached to the light control layer CFL through the adhesive layer AL. For example, the adhesive layer AL may include an optically clear adhesive (“OCA”), an optically clear resin (“OCR”), a pressure-sensitive adhesive (“PSA”), or the like.

The display panel DP may be an organic light-emitting display panel, an inorganic light-emitting display panel, or a quantum dot display panel, but this disclosure is not limited thereto. Hereinafter, the display panel DP may be described as an organic light-emitting display panel, without limitation thereto.

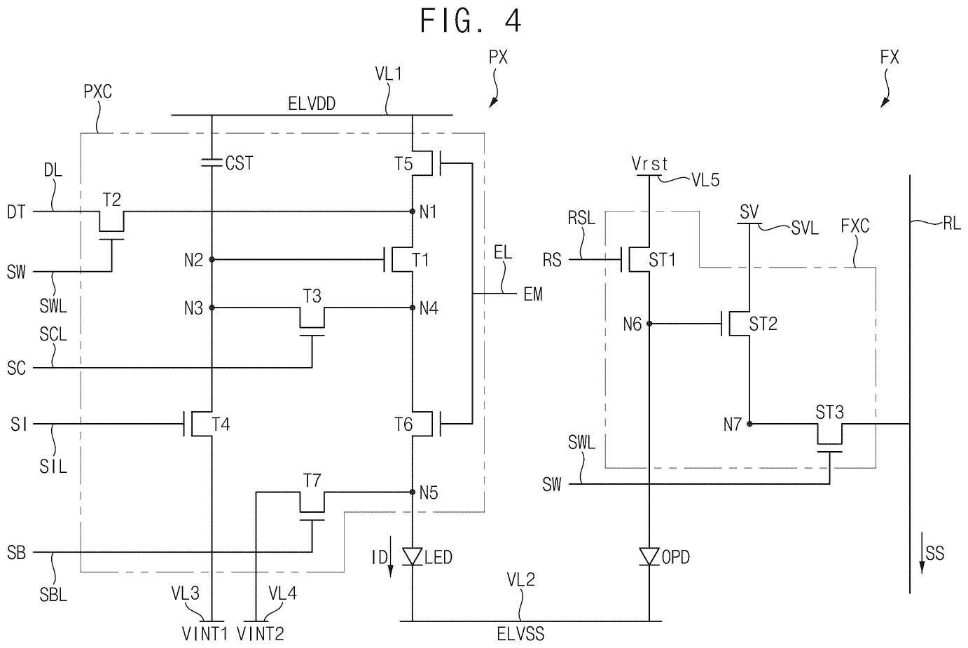

In an embodiment, the display panel DP may include a substrate SUB, a circuit layer DP_CL, an element layer DP_LED, and an encapsulation layer TFE. The substrate SUB may be a base of the display panel DP. The circuit layer DP_CL may be located on the substrate SUB. The circuit layer DP_CL may include a circuit element. For example, the circuit layer DP_CL may include a pixel driving circuit portion (e.g., a pixel driving circuit portion PXC of FIG. 4) and a sensor driving circuit portion (e.g., a sensor driving circuit portion FXC of FIG. 4). The element layer DP_LED may be located on the circuit layer DP_CL. For example, the element layer DP_LED may include a light-emitting element (e.g., a light-emitting element LED of FIG. 4) and a light-receiving element (e.g., a light-receiving element OPD of FIG. 4). The encapsulation layer TFE may be located on the element layer DP_LED. The encapsulation layer TFE may substantially seal the element layer DP_LED.

In an embodiment, the first direction DR1 and the second direction DR2 crossing the first direction DR1 may be defined. For example, the second direction DR2 may be substantially perpendicular to the first direction DR1. However, this disclosure is not limited thereto, and the second direction DR2 may form an acute angle or an obtuse angle with the first direction DR1. That is, the second direction my cross the first direction at a non-perpendicular angle, without limitation thereto. In addition, a third direction DR3 crossing a plane formed by the first direction DR1 and the second direction DR2 may be defined. For example, the third direction DR3 may be substantially perpendicular to the plane formed by the first direction DR1 and the second directions DR2. However, this disclosure is not limited thereto, and the third direction DR3 may form an acute angle or an obtuse angle with the plane formed by the first direction DR1 and the second direction DR2. That is, the third direction my cross the first direction and/or the second direction at non-perpendicular angles, without limitation thereto.

FIG. 3 schematically illustrates the display device of FIG. 1.

Referring to FIG. 3, the display device DD may include a driving controller 100, a scan driver 200, a data driver 300, a read-out circuit 400, a light-emitting driver 500, and a voltage generator 600. As described above, the non-display area (e.g., the non-display area NDA of FIG. 1) may include a plurality of drivers. Moreover, the plurality of drivers may include the driving controller 100, the scan driver 200, the data driver 300, the read-out circuit 400, the light-emitting driver 500, and the voltage generator 600.

The driving controller 100 may receive input image data IMG and an input control signal CONT from an external device. In an embodiment, the input image data IMG may include red image data, green image data, and blue image data. In an embodiment, the input image data IMG may include magenta image data, yellow image data, and cyan image data. In an embodiment, the input image data IMG may either include or further include white image data. The input control signal CONT may include a master clock signal and a data enable signal. The input control signal CONT may further include a vertical synchronization signal and a horizontal synchronization signal.

The driving controller 100 may generate a first control signal CONT1, a second control signal CONT2, a third control signal CONT3, a fourth control signal CONT4, and a data signal DATA based on the input image data IMG and the input control signal CONT. For example, the driving controller 100 may generate the first control signal CONT1 based on the input control signal CONT, and output the first control signal CONT1 to the scan driver 200. The first control signal CONT1 may include a vertical start signal and a gate clock signal. In addition, the driving controller 100 may generate the second control signal CONT2 based on the input control signal CONT, and output the second control signal CONT2 to the data driver 300. The second control signal CONT2 may include a horizontal start signal and a load signal. In addition, the driving controller 100 may generate the third control signal CONT3 based on the input control signal CONT, and output the third control signal CONT3 to the read-out circuit 400. In addition, the driving controller 100 may generate the fourth control signal CONT4 based on the input control signal CONT, and output the fourth control signal CONT4 to the light-emitting driver 500. In addition, the driving controller 100 may generate the data signal DATA based on the input image data IMG, and output the data signal DATA to the data driver 300.

The scan driver 200 may output scan signals to a plurality of scan lines in response to the first control signal CONT1. For example, the scan driver 200 may output scan signals to initialization scan lines SIL1 through SILn, compensation scan lines SCL1 through SCLn, black scan lines SBL1 through SBLn, and write scan lines SWL1 through SWLn in response to the first control signal CONT1. For example, the scan driver 200 may output an initialization scan signal (e.g., an initialization scan signal SI of FIG. 4) to the initialization scan lines SIL1 through SILn, a compensation scan signal (e.g., a compensation scan signal SC of FIG. 4) to the compensation scan lines SCL1 through SCLn, a black scan signal (e.g., a black scan signal SB of FIG. 4) to the black scan lines SBL1 through SBLn, and a write scan signal (e.g., a write scan signal SW of FIG. 4) to the write scan lines SWL1 through SWLn.

The data driver 300 may receive the second control signal CONT2 and the data signal DATA from the driving controller 100. The data driver 300 may convert the data signal DATA into an analog data voltage (e.g., a data voltage DT of FIG. 4). The data driver 300 may output the data voltage to data lines DL1 through DLm.

The read-out circuit 400 may receive the third control signal CONT3 from the driving controller 100. The read-out circuit 400 may receive a detection signal (e.g., a detection signal SS of FIG. 4) from read-out lines RL1 through RLs in response to the third control signal CONT3. The read-out circuit 400 may generate a processed detection signal PSS by processing the detection signal. The read-out circuit 400 may provide the processed detection signal PSS to the driving controller 100. The driving controller 100 may detect biometric information based on the processed detection signal PSS.

The light-emitting driver 500 may receive the fourth control signal CONT4 from the driving controller 100. The light-emitting driver 500 may generate a light-emitting control signal (e.g., a light-emitting control signal EM of FIG. 4) in response to the fourth control signal CONT4. The light-emitting driver 500 may output the light-emitting control signal to light-emitting control lines EL1 through ELn.

The voltage generator 600 may generate a first power voltage ELVDD, a second power voltage ELVSS, a first initialization voltage VINT1, a second initialization voltage VINT2, and a reset voltage Vrst. The voltage generator 600 may output the first power voltage ELVDD, the second power voltage ELVSS, the first initialization voltage VINT1, the second initialization voltage VINT2, and the reset voltage Vrst to the display area DA. The voltage generator 600 may receive a control signal from the driving controller 100. For example, the voltage generator 600 may receive a fifth control signal from the driving controller 100. The voltage generator 600 may generate the first power voltage ELVDD, the second power voltage ELVSS, the first initialization voltage VINT1, the second initialization voltage VINT2, and the reset voltage Vrst in response to the fifth control signal.

FIG. 3 illustrates an example of positions of the plurality of drivers, without limitation thereto. For example, the scan driver 200 may be spaced apart from the display area DA in a direction opposite to the first direction DR1, and the light-emitting driver 500 may be spaced apart from the display area DA in the first direction DR1. However, this disclosure is not limited thereto. For example, both the scan driver 200 and the light-emitting driver 500 may be spaced apart from the display area DA in a direction substantially opposite to the first direction DR1. For example, positions of the plurality of drivers may be variously changed, without limitation thereto.

The display area DA may be connected to initialization scan lines SIL1 through SILn, the compensation scan lines SCL1 through SCLn, the black scan lines SBL1 through SBLn, the write scan lines SWL1 through SWLn, the light-emitting control lines EL1 through ELn, the data lines DL1 through DLm, and read-out lines RL1 through RLs. For example, the initialization scan lines SIL1 through SILn may extend in the first direction DR1, and may be located along the second direction DR2. The compensation scan lines SCL1 through SCLn may extend in the first direction DR1, and may be located along the second direction DR2. The black scan lines SBL1 through SBLn may extend in the first direction DR2, and may be located along the second direction DR2. The write scan lines SWL1 through SWLn may extend in the first direction DR1, and may be located along the second direction DR2. The light-emitting control lines EL1 through ELn may extend in the first direction DR1, and may be located along the second direction DR2. The data lines DL1 through DLm may extend in the second direction DR2, and may be located along the first direction DR1. The read-out lines RL1 through RLs may extend in the second direction DR2, and may be located along the first direction DR1.

The display area DA may include a plurality of pixels PX and a plurality of sensors FX. The plurality of pixels PX may be repeatedly located along the first direction DR1 and the second direction DR2. Each of the plurality of sensors FX may be located between adjacent pixels of the plurality of pixels PX. FIG. 3 illustrates an example of positions of the plurality of sensors FX, and positions of the plurality of sensors FX may be variously changed, without limitation thereto.

Each of the plurality of pixels PX may be electrically connected to the initialization scan lines SIL1 through SILn, the compensation scan lines SCL1 through SCLn, the black scan lines SBL1 through SBLn, the write scan lines SWL1 through SWLn, the light-emitting control lines EL1 through ELn, and the data lines DL1 through DLm. For example, each of the plurality of pixels PX may be electrically connected to one initialization scan line of the initialization scan lines SIL1 through SILn, one compensation scan line of the compensation scan lines SCL1 through SCLn, one black scan line of the black scan lines SBL1 through SBLn, one write scan line of the write scan lines SWL1 through SWLn, one light-emitting control line of the light-emitting control lines EL1 through ELn, and one data line of the data lines DL1 through DLm, but this disclosure is not limited thereto.

Each of the plurality of sensors FX may be electrically connected to the write scan lines SWL1 through SWLn and the read-out lines RL1 through RLs. For example, each of the plurality of sensors FX may be electrically connected to one write scan line of the write scan lines SWL1 through SWLn and one read-out line of the read-out lines RL1 through RLs, but this disclosure is not limited thereto.

FIG. 4 illustrates a pixel and a sensor included in the display device of FIG. 3.

Referring to FIG. 4, the pixel PX may include a light-emitting element LED and a pixel driving circuit portion PXC electrically connected to the light-emitting element LED. The sensor FX may include a light-receiving element OPD and a sensor driving circuit portion FXC electrically connected to the light-receiving element OPD.

The pixel driving circuit portion PXC may include a first pixel transistor T1, a second pixel transistor T2, a third pixel transistor T3, a fourth pixel transistor T4, a fifth pixel transistor T5, a sixth pixel transistor T6, a seventh pixel transistor T7, and a capacitor CST.

In an embodiment, each of the first pixel transistor T1, the second pixel transistor T2, the third pixel transistor T3, the fourth pixel transistor T4, the fifth pixel transistor T5, the sixth pixel transistor T6, and the seventh pixel transistor T7 may be an n-type transistor. An active pattern of the n-type transistor may include an oxide semiconductor material. However, this disclosure is not limited thereto. For example, the active pattern of the n-type transistor may include a silicon semiconductor material.

In an embodiment, some of the first pixel transistor T1, the second pixel transistor T2, the third pixel transistor T3, the fourth pixel transistor T4, the fifth pixel transistor T5, the sixth pixel transistor T6, and the seventh pixel transistor T7 may be n-type transistors, and others may be p-type transistors. An active pattern of the p-type transistor may include a silicon semiconductor material.

The pixel driving circuit portion PXC may be electrically connected to a first voltage line VL1, a second voltage line VL2, a third voltage line VL3, a fourth voltage line VL4, a data line DL, a write scan line SWL, a compensation scan line SCL, an initialization scan line SIL, a black scan line SBL, and a light-emitting control line EL.

The first voltage line VL1 may apply a first power voltage ELVDD to the pixel driving circuit portion PXC. The second voltage line VL2 may apply a second power voltage ELVSS to the pixel driving circuit portion PXC. The third voltage line VL3 may apply a first initialization voltage VINT1 to the pixel driving circuit portion PXC. The fourth voltage line VL4 may apply a second initialization voltage VINT2 to the pixel driving circuit portion PXC. The data line DL may apply a data voltage DT to the pixel driving circuit portion PXC. The write scan line SWL may apply a write scan signal SW to the pixel driving circuit portion PXC. The compensation scan line SCL may apply a compensation scan signal SC to the pixel driving circuit portion PXC. The initialization scan line SIL may apply an initialization scan signal SI to the pixel driving circuit portion PXC. The black scan line SBL may apply a black scan signal SB to the pixel driving circuit portion PXC. The light-emitting control line EL may apply a light-emitting control signal EM to the pixel driving circuit portion PXC. In an embodiment, a voltage level of the first power voltage ELVDD may be higher than a voltage level of the second power voltage ELVSS.

The first pixel transistor T1 may include a gate terminal, a first terminal, and a second terminal. The gate terminal of the first pixel transistor T1 may be connected to a second node N2. The first terminal of the first pixel transistor T1 may be connected to a first node N1. The second terminal of the first pixel transistor T1 may be connected to a fourth node N4. The first pixel transistor T1 may provide a driving current ID to the light-emitting element LED.

The second pixel transistor T2 may include a gate terminal, a first terminal, and a second terminal. The gate terminal of the second pixel transistor T2 may be connected to the write scan line SWL. The first terminal of the second pixel transistor T2 may be connected to the data line DL. The second terminal of the second pixel transistor T2 may be connected to the first node N1.

The gate terminal of the second pixel transistor T2 may receive the write scan signal SW through the write scan line SWL. The second pixel transistor T2 may be turned on or off in response to the write scan signal SW. For example, when the second pixel transistor T2 is an n-type transistor, the second pixel transistor T2 may be turned off when the write scan signal SW has a negative voltage level, and may be turned on when the write scan signal SW has a positive voltage level. In addition, when the second pixel transistor T2 is a p-type transistor, the second pixel transistor T2 may be turned off when the write scan signal SW has a positive voltage level, and may be turned on when the write scan signal SW has a negative voltage level. The first terminal of the second pixel transistor T2 may receive the data voltage DT through the data line DL. The second terminal of the second pixel transistor T2 may provide the data voltage DT to the first node N1 during a period in which the second pixel transistor T2 is turned on. Accordingly, the second pixel transistor T2 may drive the first pixel transistor T1.

The third pixel transistor T3 may include a gate terminal, a first terminal, and a second terminal. The gate terminal of the third pixel transistor T3 may be connected to the compensation scan line SCL. The first terminal of the third pixel transistor T3 may be connected to the third node N3. The second terminal of the third pixel transistor T3 may be connected to the fourth node N4.

The gate terminal of the third pixel transistor T3 may receive the compensation scan signal SC through the compensation scan line SCL. The third pixel transistor T3 may be turned on or off in response to the compensation scan signal SC. For example, when the third pixel transistor T3 is an n-type transistor, the third pixel transistor T3 may be turned off when the compensation scan signal SC has a negative voltage level, and may be turned on when the compensation scan signal SC has a positive voltage level. In addition, when the third pixel transistor T3 is a p-type transistor, the third pixel transistor T3 may be turned off when the compensation scan signal SC has a positive voltage level, and may be turned on when the compensation scan signal SC has a negative voltage level. During a period in which the third pixel transistor T3 is turned on, the third pixel transistor T3 may diode-couple the gate terminal of the first pixel transistor T1 and the second terminal of the first pixel transistor T1.

The fourth pixel transistor T4 may include a gate terminal, a first terminal, and a second terminal. The gate terminal of the fourth pixel transistor T4 may be connected to the initialization scan line SIL. The first terminal of the fourth pixel transistor T4 may be connected to the third voltage line VL3. The second terminal of the fourth pixel transistor T4 may be connected to the second node N2. For example, the second terminal of the fourth pixel transistor T4 may be connected to the second node N2 through the third node N3.

The gate terminal of the fourth pixel transistor T4 may receive the initialization scan signal SI through the initialization scan line SIL. The fourth pixel transistor T4 may be turned on or off in response to the initialization scan signal SI. For example, when the fourth pixel transistor T4 is an n-type transistor, the fourth pixel transistor T4 may be turned off when the initialization scan signal SI has a negative voltage level, and may be turned on when the initialization scan signal SI has a positive voltage level. In addition, when the fourth pixel transistor T4 is a p-type transistor, the fourth pixel transistor T4 may be turned off when the initialization scan signal SI has a positive voltage level, and may be turned on when the initialization scan signal SI has a negative voltage level. During a period in which the fourth pixel transistor T4 is turned on, the fourth pixel transistor T4 may provide the first initialization voltage VINT1 to the second node N2. Accordingly, the fourth pixel transistor T4 may initialize potential of the gate terminal of the first pixel transistor T1.

The fifth pixel transistor T5 may include a gate terminal, a first terminal, and a second terminal. The gate terminal of the fifth pixel transistor T5 may be connected to the light-emitting control line EL. The first terminal of the fifth pixel transistor T5 may be connected to the first voltage line VL1. The second terminal of the fifth pixel transistor T5 may be connected to the first node N1.

The gate terminal of the fifth pixel transistor T5 may receive the light-emitting control signal EM through the light-emitting control line EL. The fifth pixel transistor T5 may be turned on or off in response to the light-emitting control signal EM. For example, when the fifth pixel transistor T5 is an n-type transistor, the fifth pixel transistor T5 may be turned off when the light-emitting control signal EM has a negative voltage level, and may be turned on when the light-emitting control signal EM has a positive voltage level. In addition, when the fifth pixel transistor T5 is a p-type transistor, the fifth pixel transistor T5 may be turned off when the light-emitting control signal EM has a positive voltage level, and may be turned on when the light-emitting control signal EM has a negative voltage level. During a period in which the fifth pixel transistor T5 is turned on, the fifth pixel transistor T5 may provide the first power voltage ELVDD to the first node N1.

The sixth pixel transistor T6 may include a gate terminal, a first terminal, and a second terminal. The gate terminal of the sixth pixel transistor T6 may be connected to the light-emitting control line EL. The first terminal of the sixth pixel transistor T6 may be connected to the fourth node N4. The second terminal of the sixth pixel transistor T6 may be connected to a fifth node N5.

The gate terminal of the sixth pixel transistor T6 may receive the light-emitting control signal EM through the light-emitting control line EL. The sixth pixel transistor T6 may be turned on or off in response to the light-emitting control signal EM. For example, when the sixth pixel transistor T6 is an n-type transistor, the sixth pixel transistor T6 may be turned off when the light-emitting control signal EM has a negative voltage level, and may be turned on when the light-emitting control signal EM has a positive voltage level. In addition, when the sixth pixel transistor T6 is a p-type transistor, the sixth pixel transistor T6 may be turned off when the light-emitting control signal EM has a positive voltage level, and may be turned on when the light-emitting control signal EM has a negative voltage level.

The seventh pixel transistor T7 may include a gate terminal, a first terminal, and a second terminal. The gate terminal of the seventh pixel transistor T7 may be connected to the black scan line SBL. The first terminal of the seventh pixel transistor T7 may be connected to the fourth voltage line VL4. The second terminal of the seventh pixel transistor T7 may be connected to the fifth node N5.

The seventh pixel transistor T7 may receive the black scan signal SB through the black scan line SBL. The seventh pixel transistor T7 may be turned on or off in response to the black scan signal SB. For example, when the seventh pixel transistor T7 is an n-type transistor, the seventh pixel transistor T7 may be turned off when the black scan signal SB has a negative voltage level, and may be turned on when the black scan signal SB has a positive voltage level. In addition, when the seventh pixel transistor T7 is a p-type transistor, the seventh pixel transistor T7 may be turned off when the black scan signal SB has a positive voltage level, and may be turned on when the black scan signal SB has a negative voltage level. During a period in which the seventh pixel transistor T7 is turned on, the seventh pixel transistor T7 may provide the second initialization voltage VINT2 to the fifth node N5.

The capacitor CST may include a first terminal and a second terminal. The first terminal of the capacitor CST may be connected to the first voltage line VL1. The second terminal of the capacitor CST may be connected to the second node N2. Charges corresponding to a difference between a voltage of the gate terminal of the first pixel transistor T1 and the first power voltage ELVDD may be stored in the capacitor CST.

The light-emitting element LED may include a first terminal and a second terminal. The first terminal of the light-emitting element LED may be connected to the fifth node N5. The second terminal of the light-emitting element LED may be connected to the second voltage line VL2. For example, the first terminal of the light-emitting element LED may be an anode terminal, and the second terminal of the light-emitting element LED may be a cathode terminal.

As illustrated in FIG. 4, the pixel driving circuit portion PXC may include seven transistors and one capacitor. However, this disclosure is not limited thereto, and the number of transistors and capacitors included in the pixel driving circuit portion PXC may be variously changed, without limitation thereto.

The sensor driving circuit portion FXC may include a first sensor transistor ST1, a second sensor transistor ST2, and a third sensor transistor ST3. In an embodiment, each of the first sensor transistor ST1, the second sensor transistor ST2, and the third sensor transistor ST3 may be an n-type transistor. An active pattern of the n-type transistor may include an oxide semiconductor material. However, this disclosure is not limited thereto, and the active pattern of the n-type transistor may include a silicon semiconductor material.

In an embodiment, some of the first sensor transistor ST1, the second sensor transistor ST2, and the third sensor transistor ST3 may be n-type transistors, and others may be p-type transistors. An active pattern of the p-type transistor may include a silicon semiconductor material.

The sensor driving circuit portion FXC may be electrically connected to a fifth voltage line VL5, a reset control line RSL, a sensing driving line SVL, a read-out line RL, and a write scan line SWL.

The fifth voltage line VL5 may apply a reset voltage Vrst to the sensor driving circuit portion FXC. The reset control line RSL may apply a reset control signal RS to the sensor driving circuit portion FXC. The sensing driving line SVL may apply a sensing driving voltage SV to the sensor driving circuit portion FXC. The sensor driving circuit portion FXC may provide a detection signal SS to the read-out line RL. The write scan line SWL may provide a write scan signal SW to the sensor driving circuit portion FXC.

The first sensor transistor ST1 may include a gate terminal, a first terminal, and a second terminal. The gate terminal of the first sensor transistor ST1 may be connected to the reset control line RSL. The first terminal of the first sensor transistor ST1 may be connected to the fifth voltage line VL5. The second terminal of the first sensor transistor ST1 may be connected to a sixth node N6.

The gate terminal of the first sensor transistor ST1 may receive the reset control signal RS through the reset control line RSL. The first sensor transistor ST1 may be turned on or off in response to the reset control signal RS. For example, when the first sensor transistor ST1 is an n-type transistor, the first sensor transistor ST1 may be turned off when the reset control signal RS has a negative voltage level, and may be turned on when the reset control signal RS has a positive voltage level. In addition, when the first sensor transistor ST1 is a p-type transistor, the first sensor transistor ST1 may be turned off when the reset control signal RS has a positive voltage level, and may be turned on when the reset control signal RS has a negative voltage level. During a period in which the first sensor transistor ST1 is turned on, the sixth node N6 may be initialized to the reset voltage Vrst. For example, the reset voltage Vrst may have a voltage level lower than a voltage of the second power voltage ELVSS during a period in which the first sensor transistor ST1 is turned on. For example, the reset voltage Vrst may be a DC voltage maintained at a voltage level lower than a voltage of the second power voltage ELVSS, but this disclosure is not limited thereto.

The second sensor transistor ST2 may include a gate terminal, a first terminal, and a second terminal. The gate terminal of the second sensor transistor ST2 may be connected to the sixth node N6. The first terminal of the second sensor transistor ST2 may be connected to the sensing driving line SVL. The second terminal of the second sensor transistor ST2 may be connected to a seventh node N7.

The second sensor transistor ST2 may be turned on according to potential of the sixth node N6 to apply the sensing driving voltage SV to the seventh node N7. In an embodiment, the sensing driving voltage SV may be one of the first power voltage ELVDD, the first initialization voltage VINT1, and the second initialization voltage VINT2. When the sensing driving voltage SV is the first power voltage ELVDD, the first terminal of the second sensor transistor ST2 may be electrically connected to the first voltage line VL1. In this case, the first voltage line VL1 may be connected to each of the pixel driving circuit portion PXC and the sensor driving circuit portion FXC to apply the first power voltage ELVDD to each of the pixel driving circuit portion PXC and the sensor driving circuit portion FXC. When the sensing driving voltage SV is the first initialization voltage VINT1, the first terminal of the second sensor transistor ST2 may be connected to the third voltage line VL3. In this case, the third voltage line VL3 may be connected to each of the pixel driving circuit portion PXC and the sensor driving circuit portion FXC to apply the first initialization voltage VINT1 to each of the pixel driving circuit portion PXC and the sensor driving circuit portion FXC. When the sensing driving voltage SV is the second initialization voltage VINT2, the second terminal of the second sensor transistor ST2 may be connected to the fourth voltage line VL4. In this case, the fourth voltage line VL4 may be connected to each of the pixel driving circuit portion PXC and the sensor driving circuit portion FXC to apply the second initialization voltage VINT2 to each of the pixel driving circuit portion PXC and the sensor driving circuit portion FXC.

The third sensor transistor ST3 may include a gate terminal, a first terminal, and a second terminal. The gate terminal of the third sensor transistor ST3 may be connected to the write scan line SWL. The first terminal of the third sensor transistor ST3 may be connected to the seventh node N7. The second terminal of the third sensor transistor ST3 may be connected to the read-out line RL.

The gate terminal of the third sensor transistor ST3 may receive the write scan signal SW through the write scan line SWL. The third sensor transistor ST3 may be turned on or off in response to the write scan signal SW. For example, when the third sensor transistor ST3 is an n-type transistor, the third sensor transistor ST3 may be turned off when the write scan signal SW has a negative voltage level, and may be turned on when the write scan signal SW has a positive voltage level. In addition, when the third sensor transistor ST3 is a p-type transistor, the third sensor transistor ST3 may be turned off when the write scan signal SW has a positive voltage level, and may be turned on when the write scan signal SW has a negative voltage level. During a period in which the third sensor transistor ST3 is turned on, the third sensor transistor ST3 may provide the detection signal SS to the read-out line RL.

For example, each of the first sensor transistor ST1, the second sensor transistor ST2, and the third sensor transistor ST3 included in the sensor driving circuit portion FXC may be referred to as a sensor transistor.

As illustrated in FIG. 4, the sensor driving circuit portion FXC may include three transistors. However, this disclosure is not limited thereto, and the number of transistors included in the sensor driving circuit portion FXC may be variously changed, without limitation thereto. For example, the number of sensor transistors may be variously changed, without limitation thereto.

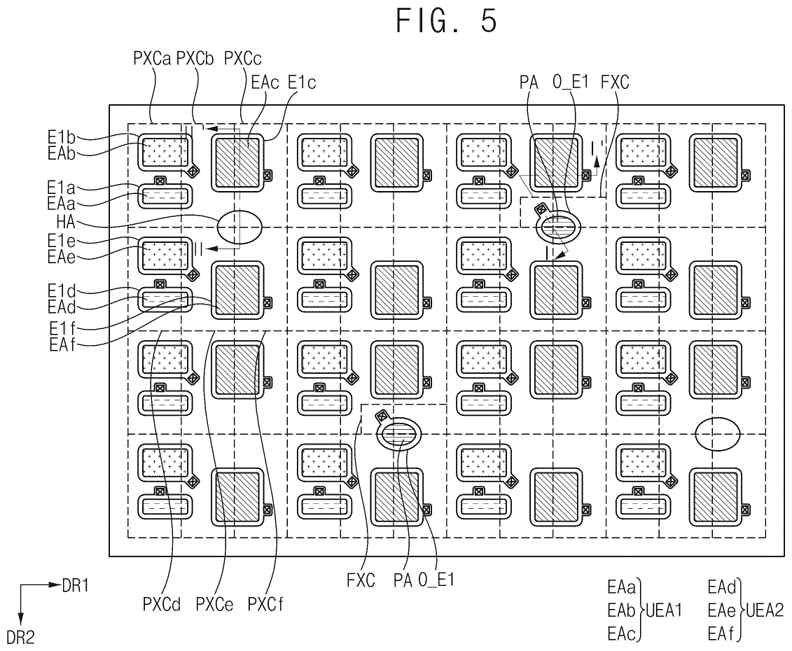

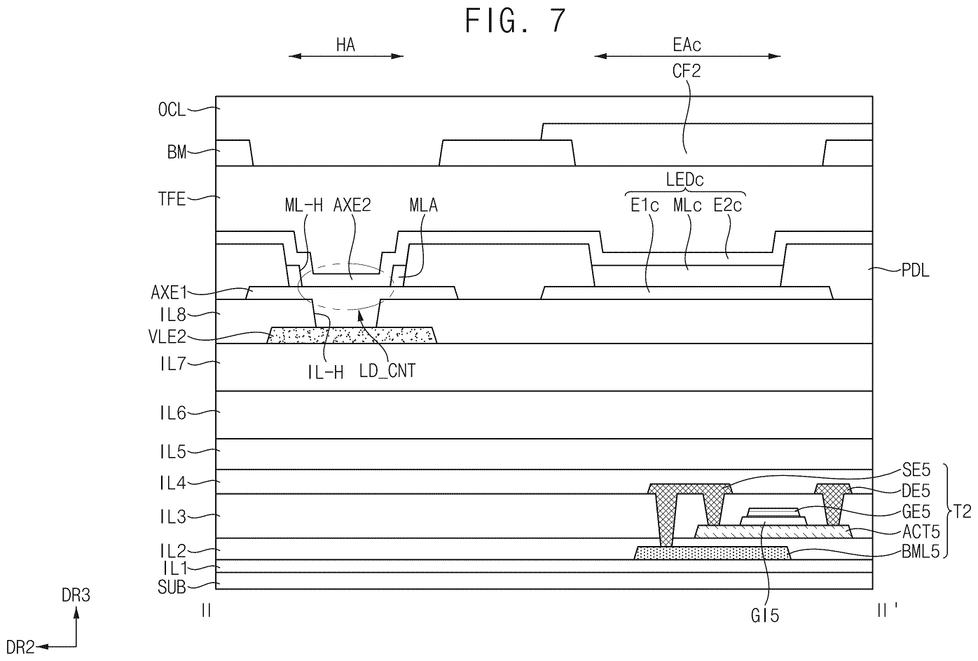

FIG. 6 illustrates a cross-section of the display device of FIG. 5 taken along folded line I-I′. FIG. 7 illustrates a cross-section of the display device of FIG. 5 taken along line II-II′.

Referring to FIG. 5, the display device (e.g., the display device DD of FIG. 1) may include the first unit light-emitting area UEA1 and the second unit light-emitting area UEA2. In an embodiment, the first unit light-emitting area UEA1 and the second unit light-emitting area UEA2 may be alternately located along the second direction DR2. For example, the first unit light-emitting area UEA1 and the second unit light-emitting area UEA2 may be spaced apart from each other in the second direction DR2. The first unit light-emitting area UEA1 may be repeatedly located along the first direction DR1. For example, a plurality of first unit light-emitting areas UEA1 may be located along the first direction DR1. For example, the first unit light-emitting area UEA1 may include a plurality of first unit light-emitting areas UEA1 located along the first direction DR1. The second unit light-emitting area UEA2 may be repeatedly located along the first direction DR1. For example, the plurality of second unit light-emitting areas UEA2 may be located along the first direction DR1. For example, the second unit light-emitting area UEA2 may include a plurality of second unit light-emitting areas UEA2 arranged along the first direction DR1.

However, this disclosure is not limited thereto, and number of different (or, distinct) unit light-emitting areas included in the display device or arrangement relationship between different (or, distinct) unit light-emitting areas may be variously changed according to configurations.

The first unit light-emitting area UEA1 may include a first light-emitting area EAa, a second light-emitting area EAb, and a third light-emitting area EAc. The first light-emitting area EAa, the second light-emitting area EAb, and the third light-emitting area EAc may be defined by a pixel opening of a pixel defining layer (e.g., a pixel defining layer PDL of FIG. 6) to be described later. Each of the first light-emitting area EAa, the second light-emitting area EAa, and the third light-emitting area EAc may be an area in which light is emitted by a light-emitting element. For example, the first light-emitting area EAa may be an area in which light is emitted by a first light-emitting element (not shown). In addition, the second light-emitting area EAb may be an area in which light is emitted by a second light-emitting element (not shown). In addition, the third light-emitting area EAc may be an area in which light is emitted by a third light-emitting element (e.g., a third light-emitting element LEDc of FIG. 6). The first light-emitting element, the second light-emitting element, and the third light-emitting element may have substantially a same structure as each other.

The first light-emitting area EAa may emit a first light, the second light-emitting area EAb may emit a second light, and the third light-emitting area EAc may emit a third light. For example, the first light may be red light, the second light may be green light, and the third light may be blue light, but this disclosure is not limited thereto.

The second unit light-emitting area UEA2 may include a fourth light-emitting area EAd, a fifth light-emitting area EAe, and a sixth light-emitting area EAf. The fourth light-emitting area EAd, the fifth light-emitting area EAe, and the sixth light-emitting area EAf may be defined by the pixel opening of the pixel defining layer. For example, each of the fourth light-emitting area EAd, the fifth light-emitting area EAe, and the sixth light-emitting area EAf may be an area through which light is emitted by a light-emitting element. For example, the fourth light-emitting area EAd may be an area through which light is emitted by a fourth light-emitting element (not shown). In addition, the fifth light-emitting area EAe may be an area through which light is emitted by a fifth light-emitting element (not shown). In addition, the sixth light-emitting area EAf may be an area through which light is emitted by a sixth light-emitting element (not shown). The first light-emitting element, the second light-emitting element, the third light-emitting element, the fourth light-emitting element, the fifth light-emitting element and the sixth light-emitting element may have substantially a same structure as each other. A structure of the third light-emitting element will be described later in more detail with reference to FIG. 6.

The fourth light-emitting area EAd may emit the fourth light, the fifth light-emitting area EAe may emit the fifth light, and the sixth light-emitting area EAf may emit the sixth light. In an embodiment, the fourth light and the first light may have substantially a same wavelength. For example, the fourth light may be red light. However, this disclosure is not limited thereto, and the fourth light and the first light may have different wavelengths. In an embodiment, the fifth light and the second light may have substantially a same wavelength. For example, the fifth light may be green light. However, this disclosure is not limited thereto, and the fifth light and the second light may have different wavelengths. In an embodiment, the sixth light and the third light may have substantially a same wavelength. For example, the sixth light may be blue light. However, this disclosure is not limited thereto, and the sixth light and the third light may have different wavelengths.

Arrangement relationship between the first light-emitting area EAa, the second light-emitting area EAb, and the third light-emitting area EAc may be substantially the same for each first unit light-emitting area UEA1. For example, a relative position of the third light-emitting area EAc with respect to the first light-emitting area EAa may be substantially the same for each first unit light-emitting area UEA1. In addition, arrangement relationship between the fourth light-emitting area EAd, the fifth light-emitting area EAe, and the sixth light-emitting area EAf may be substantially the same for each second unit light-emitting area UEA2. For example, a relative position of the sixth light-emitting area EAf with respect to the fourth light-emitting area EAd may be substantially the same for each second unit light-emitting area UEA2.

In an embodiment, the first unit light-emitting area UEA1 and the second unit light-emitting area UEA2 may be divided based on arrangement relationship between a plurality of light-emitting areas. For example, the first unit light-emitting area UEA1 and the second unit light-emitting area UEA2 may be divided based on a relative position of the light-emitting area emitting the third light with respect to the light-emitting area emitting the first light. For example, a relative position of the third light-emitting area EAc with respect to the first light-emitting area EAa and a relative position of the sixth light-emitting area EAf with respect to the fourth light-emitting area EAd may be different from each other. In addition, the first unit light-emitting area UEA1 and the second unit light-emitting area UEA2 may be divided based on a relative position of the light-emitting area emitting the third light with respect to the light-emitting area emitting the second light. For example, a relative position of the third light-emitting area EAc with respect to the second light-emitting area EAb and a relative position of the sixth light-emitting area EAf with respect to the fifth light-emitting area EAe may be different from each other. In an embodiment, a relative position of the second light-emitting area EAb with respect to the first light-emitting area EAa and a relative position of the fifth light-emitting area EAe with respect to the fourth light-emitting area EAd may be substantially the same, but this disclosure is not limited thereto.

However, this disclosure is not limited thereto, and the display device may have one unit light-emitting area. In this case, the one unit light-emitting area may be repeatedly located along the first direction DR1 and the second direction DR2. Arrangement relationship between the light-emitting area emitting the first light, the light-emitting area emitting the second light, and the light-emitting area emitting the third light may be substantially the same.

FIG. 5 illustrates an area in which 16 unit light-emitting areas UEA1 and UEA2 forming a matrix of four rows and four columns are arranged, without limitation thereto.

The display device may include a first pixel driving circuit portion PXCa, a second pixel driving circuit portion PXCb, a third pixel driving circuit portion PXCc, a fourth pixel driving circuit portion PXCd, a fifth pixel driving circuit portion PXCe, and a sixth pixel driving circuit portion PXCf, and a plurality of first electrodes including a first electrode E1a having a terminal in the first pixel driving circuit portion PXCa, a first electrode E1b having a terminal in the second pixel driving circuit portion PXCb, a first electrode E1c having a terminal in the third pixel driving circuit portion PXCc, a first electrode E1d having a terminal in the fourth pixel driving circuit portion PXCd, a first electrode E1e having a terminal in the fifth pixel driving circuit portion PXCe, and a first electrode E1f having a terminal in the sixth pixel driving circuit portion PXCf.

Each of the first pixel driving circuit portion PXCa, the second pixel driving circuit portion PXCb, the third pixel driving circuit portion PXCc, the fourth pixel driving circuit portion PXCd, the fifth pixel driving circuit portion PXCe, and the sixth pixel driving circuit portion PXCf may correspond to the pixel driving circuit portion PXC described with reference to FIG. 4. Each of the first pixel driving circuit portion PXCa, the second pixel driving circuit portion PXCb, the third pixel driving circuit portion PXCc, the fourth pixel driving circuit portion PXCd, the fifth pixel driving circuit portion PXCe, and the sixth pixel driving circuit portion PXCf may include at least one transistor and at least one capacitor.

In FIG. 5, the first pixel driving circuit portion PXCa, the second pixel driving circuit portion PXCb, and the third pixel driving circuit portion PXCc may be illustrated to be sequentially arranged along the first direction DR1 in a generally quadrilateral or rectangular shape However, this disclosure is not limited thereto, and shapes and arrangements of the first pixel driving circuit portion PXCa, the second pixel driving circuit portion PXCb, and the third pixel driving circuit portion PXCc may be variously changed, without limitation thereto.

In addition, the fourth pixel driving circuit portion PXCd, the fifth pixel driving circuit portion PXCe, and the sixth pixel driving circuit portion PXCf may be illustrated to be sequentially arranged along the first direction DR1 in a rectangular shape. However, this disclosure is not limited thereto, and shapes and arrangements of the fourth pixel driving circuit portion PXCd, the fifth pixel driving circuit portion PXCe, and the sixth pixel driving circuit portion PXCf may be variously changed, without limitation thereto.

For example, the driving circuit portions may each have any substantially same tiled or tessellated shape, such as a rectangle, parallelogram, hexagon, or a 13-sided einstein tile. For example, different driving circuit portions may be configured as different shapes in a combination of complementary tiled shapes, such as octagons and squares; octagons, irregular hexagons and squares; octagons, irregular hexagons, diamonds and squares; octagons, irregular hexagons, regular hexagons, diamonds, and squares; or bow-ties (or wrenches), octagons, irregular hexagons, regular hexagons, diamonds, and squares; without limitation thereto.

The first electrode E1a may be at least partially located in the first light-emitting area EAa. In an embodiment, the first electrode E1a may be electrically connected to the first pixel driving circuit portion PXCa. For example, the first electrode E1a may be electrically connected to one transistor included in the first pixel driving circuit portion PXCa. For example, the first electrode E1a may be electrically connected to the one transistor included in the first pixel driving circuit portion PXCa through a connection electrode.

The first electrode E1b may be at least partially located in the second light-emitting area EAb. In an embodiment, the first electrode E1b may be electrically connected to the second pixel driving circuit portion PXCb. For example, the first electrode E1b may be electrically connected to one transistor included in the second pixel driving circuit portion PXCb. For example, the first electrode E1b may be electrically connected to the one transistor included in the second pixel driving circuit portion PXCb through a connection electrode.

The first electrode E1c may be at least partially located in the third light-emitting area EAc. In an embodiment, the first electrode E1c may be electrically connected to the third pixel driving circuit portion PXCc. For example, the first electrode E1c may be electrically connected to one transistor (e.g., the sixth pixel transistor T6 of FIG. 6) included in the third pixel driving circuit portion PXCc. For example, the first electrode E1c may be electrically connected to the one transistor included in the third pixel driving circuit portion PXCc through a first connection electrode (e.g., a first connection electrode CNE1 of FIG. 6) and a second connection electrode (e.g., a second connection electrode CNE2 of FIG. 6).

The first electrode E1d may be at least partially located in the fourth light-emitting area EAd. In an embodiment, the first electrode E1d may be electrically connected to the fourth pixel driving circuit portion PXCd. For example, the first electrode E1d may be electrically connected to one transistor included in the fourth pixel driving circuit portion PXCd. For example, the first electrode E1d may be electrically connected to the one transistor included in the fourth pixel driving circuit portion PXCd through a connection electrode.

The first electrode E1e may be at least partially located in the fifth light-emitting area EAe. In an embodiment, the first electrode E1e may be electrically connected to the fifth pixel driving circuit portion PXCe. For example, the first electrode E1e may be electrically connected to one transistor included in the fifth pixel driving circuit portion PXCe. For example, the first electrode E1e may be electrically connected to the one transistor included in the fifth pixel driving circuit portion PXCe through a connection electrode.

The first electrode E1f may be at least partially located in the sixth light-emitting area EAf. In an embodiment, the first electrode E1f may be electrically connected to the sixth pixel driving circuit portion PXCf. For example, the first electrode E1f may be electrically connected to one transistor included in the sixth pixel driving circuit portion PXCf. For example, the first electrode E1f may be electrically connected to the one transistor included in the sixth pixel driving circuit portion PXCf through a connection electrode.

In an embodiment, the display device may further include a hole area HA. A first sub-electrode AXE1 and a second sub-electrode AXE2 of FIG. 7 may contact each other in the hole area HA. In addition, the first sub-electrode AXE1 of FIG. 7 may contact a second voltage pattern VLE2 of FIG. 7 in the hole area HA. A cross-sectional structure of the hole area HA may be described in greater detail, infra, with reference to FIG. 7.

As described above, the plurality of first unit light-emitting areas UEA1 may be located along the first direction DR1. In addition, the plurality of second unit light-emitting areas UEA2 may be located along the first direction DR1 and offset from the plurality of first unit light-emitting areas UEA1 in the second direction DR2. In an embodiment, the hole area HA may be located in at least a portion between the first unit light-emitting areas UEA1 and the second unit light-emitting areas UEA2 in a plan view. For example, an intermediate area may be defined between the first unit light-emitting areas UEA1 and the second unit light-emitting areas UEA2 in a plan view, and the hole area HA may be located in at least a portion of the intermediate area. The intermediate area may contact the first unit light-emitting areas UEA1 in the second direction DR2, and may contact the second unit light-emitting areas UEA2 in a direction substantially opposite to the second direction DR2. The intermediate area may extend in the first direction DR1. As described above, the first unit light-emitting area UEA1 and the second unit light-emitting area UEA2 may be alternately located along the second direction DR2. Accordingly, a plurality of intermediate areas may be located along the second direction DR2.

For example, the hole area HA may be located between the third light-emitting area EAc and the sixth light-emitting area EAf in a plan view. For example, the hole area HA may be spaced apart from the third light-emitting area EAc in the second direction DR2, and may be spaced apart from the sixth light-emitting area EAf in a direction opposite to the second direction DR2. However, this disclosure is not limited thereto. For example, the hole area HA may be located between the first light-emitting area EAa and the fifth light-emitting area EAe in a plan view. In this case, the hole area HA may be spaced apart from the first light-emitting area EAa in the second direction DR2, and may be spaced apart from the fifth light-emitting area EAe in a direction opposite to the second direction DR2.

The hole area HA may include a plurality of hole areas HA located in at least a portion between the first unit light-emitting areas UEA1 and the second unit light-emitting areas UEA2 in a plan view. For example, the hole area HA may include a plurality of hole areas HA located in at least a portion of the intermediate area. Positions of the hole areas HA in a plan view may be variously changed, without limitation thereto. For example, as illustrated in FIG. 5, the hole area HA may be located between the first unit light-emitting area UEA1 located in a first row and a first column and the second unit light-emitting area UEA2 located in the second row and the first column. In addition, the hole area HA may be located between the first unit light-emitting area UEA1 located in a third row and a fourth column and the second unit light-emitting area UEA2 located in the fourth row and the fourth column. A distance between adjacent hole areas among the plurality of hole areas HA may be substantially constant over the display area (e.g., the display area DA of FIG. 1). For example, a distance between adjacent hole areas among the plurality of hole areas HA may be about 3 mm, but this disclosure is not limited thereto. For example, a distance between adjacent hole areas among the plurality of hole areas HA may be about two rows and three columns, without limitation thereto.

The display device may further include a light-receiving area PA. The light-receiving area PA may be defined by a light-receiving opening of the pixel defining layer. A light-receiving element (e.g., a light-receiving element OPD of FIG. 6) may be located in the light-receiving area PA. A cross-sectional structure of the light-receiving area PA may be described in greater detail, infra, with reference to FIG. 6.

As described above, the plurality of first unit light-emitting areas UEA1 may be located along the first direction DR1. In addition, the plurality of second unit light-emitting areas UEA2 may be located along the first direction DR1. In an embodiment, the light-receiving area PA may be located in at least a portion between the first unit light-emitting areas UEA1 and the second unit light-emitting areas UEA2 in a plan view. For example, the light-receiving area PA may be located in at least a portion of the intermediate area.

For example, the light-receiving area PA may be located between the third light-emitting area EAc and the sixth light-emitting area EAf in a plan view. For example, the light-receiving area PA may be spaced apart from the third light-emitting area EAc in the second direction DR2, and may be spaced apart from the sixth light-emitting area EAf in a direction opposite to the second direction DR2. However, this disclosure is not limited thereto, and the light-receiving area PA may be located between the first light-emitting area EAa and the fifth light-emitting area EAe in a plan view. In this case, the light-receiving area PA may be spaced apart from the first light-emitting area EAa in the second direction DR2, and may be spaced apart from the fifth light-emitting area EAe in a direction opposite to the second direction DR2.

The light-receiving area PA may include a plurality of light-receiving areas PA located in at least a portion between the first unit light-emitting areas UEA1 and the second unit light-emitting areas UEA2 in a plan view. For example, the light-receiving area PA may include a plurality of light-receiving areas PA located in at least a portion of the intermediate area. Positions of the light-receiving areas PA in a plan view may be variously changed, without limitation thereto. For example, as illustrated in FIG. 5, the light-receiving area PA may be located between the first unit light-emitting area UEA1 located in a first row and a third column and the second unit light-emitting area UEA2 located in a second row and a third column. In addition, the light-receiving area PA may be located between the first unit light-emitting area UEA1 located in a third row and a second column and the second unit light-emitting area UEA2 located in a fourth row and a second column. A separation distance between adjacent light-receiving areas of the plurality of light-receiving areas PA may be substantially constant over the display area.

In an embodiment, the light-receiving area PA and the hole area HA may be spaced apart from each other in a plan view. In addition, as illustrated in FIG. 5, the light-receiving area PA may at least partially overlap the hole area HA in the first direction DR1. However, this disclosure is not limited thereto, and the light-receiving area PA and the hole area HA may be located to at least partially overlap each other in the second direction DR2. For example, a distance between a light-receiving area PA among the plurality of light-receiving areas PA and a next hole area HA among the plurality of hole areas HA may be about two rows and one column, without limitation thereto.

In an embodiment, a distance between the light-receiving area PA and the third light-emitting area EAc adjacent to the light-receiving area PA and a distance between the hole area HA and the third light-emitting area EAc adjacent to the hole area HA may be substantially the same. In addition, a distance between the light-receiving area PA and the sixth light-emitting area EAf adjacent to the light-receiving area PA and a distance between the hole area HA and the sixth light-emitting area EAf adjacent to the hole area HA may be substantially the same.

However, this disclosure is not limited thereto, and in an embodiment, the distance between the light-receiving area PA and the third light-emitting area EAc adjacent to the light-receiving area PA and the distance between the hole area HA and the third light-emitting area EAc adjacent to the hole area HA may be different from each other. In addition, the distance between the light-receiving area PA and the sixth light-emitting area EAf adjacent to the light-receiving area PA and the distance between the hole area HA and the sixth light-emitting area EAf adjacent to the hole area HA may be different from each other.

If only the hole area HA is located in a portion of the intermediate area, a separate area for the light-receiving area PA may be used, but a resolution of the display device may be lowered. For example, as a space for each of a plurality of light-emitting areas, the hole area HA, and the light-receiving area PA is separately allocated, the resolution of the display device may be lowered. According to an embodiment, the light-receiving area PA may be located in a portion of the intermediate area in which the hole area HA is somewhat located. For example, the light-receiving area PA may be located by utilizing the intermediate area in which the hole area HA is somewhat located. Accordingly, the light-receiving area PA, which senses a user's biometric information may be included in the display device without reducing the resolution of the display device. In addition, as the display device includes the light-receiving area PA in which the light-receiving element is located, an input sensor layer for sensing the user's biometric information need not be separately allocated. The input sensor layer may be located on an encapsulation layer (e.g., an encapsulation layer TFE of FIG. 6). In addition, the input sensor layer may include a plurality of conductive layers and a plurality of insulating layers.

The display device may further include a sensor driving circuit portion FXC and a first sensing electrode O_E1. The sensor driving circuit portion FXC may correspond to the sensor driving circuit portion FXC described with reference to FIG. 4. For example, the sensor driving circuit portion FXC may include at least one transistor. The sensor driving circuit portion FXC may be located only at a portion where the light-receiving area PA is located.

The sensor driving circuit portion FXC may have a rectangular shape in a plan view, but this disclosure is not limited thereto. In an embodiment, the sensor driving circuit portion FXC may at least partially overlap some of the first pixel driving circuit portion PXCa, the second pixel driving circuit portion PXCb, the third pixel driving circuit portion PXCc, the fourth pixel driving circuit portion PXCd, the fifth pixel driving circuit portion PXCe, and the sixth pixel driving circuit portion PXCf in a plan view. For example, as illustrated in FIG. 5, the sensor driving circuit portion FXC may at least partially overlap each of the second pixel driving circuit portion PXCb and the third pixel driving circuit portion PXCc in a plan view. For example, the sensor driving circuit portion FXC may at least partially overlap each of the first pixel driving circuit portion PXCa, the second pixel driving circuit portion PXCb, and the third pixel driving circuit portion PXCc in a plan view. For example, the sensor driving circuit portion FXC may at least partially overlap each of the second pixel driving circuit portion PXCb, the third pixel driving circuit portion PXCc, the fifth pixel driving circuit portion PXCe, and the sixth pixel driving circuit portion PXCf in a plan view. For example, the sensor driving circuit portion FXC may at least partially overlap each of the first pixel driving circuit portion PXCa, the second pixel driving circuit portion PXCb, the third pixel driving circuit portion PXCc, the fourth pixel driving circuit portion PXCd, the fifth pixel driving circuit portion PXCe, and the sixth pixel driving circuit portion PXCf in a plan view.

The first sensing electrode O_E1 may be located in the light-receiving area PA. In an embodiment, the first sensing electrode O_E1 may be electrically connected to the sensor driving circuit portion FXC. For example, the first sensing electrode O_E1 may be electrically connected to one transistor (e.g., a second sensor transistor ST2 of FIG. 6) included in the sensor driving circuit portion FXC.

Referring now to FIG. 6, the display device may include the display panel DP and the light control layer CFL. The display panel DP may include the substrate SUB, the circuit layer DP_CL, the element layer DP_LED, and the encapsulation layer TFE.

The circuit layer DP_CL may be located on the substrate SUB. The element layer DP_LED may be located on the circuit layer DP_CL. The encapsulation layer TFE may be located on the element layer DP_LED. The light control layer CFL may be located on the display panel DP. The light control layer CFL may include a first color filter CF1, a second color filter CF2, a black matrix BM, and an overcoating layer OCL. For convenience of description, substantially duplicate description of the window WM of FIG. 2 may be omitted for FIG. 6.

The substrate SUB may include a transparent material or an opaque material. The substrate SUB may be formed of a transparent resin substrate. Example of the transparent resin substrate may include a polyimide substrate. In this case, the polyimide substrate may include a first organic layer, a first barrier layer, a second organic layer, and/or the like. Optionally, the substrate SUB may include a quartz substrate (e.g. a synthetic quartz substrate, a fluorine-doped quartz substrate), a calcium fluoride substrate, a soda-lime glass substrate, a non-alkali glass substrate, and/or the like. These and comparable materials may be used alone or in combination with each other.

The circuit layer DP_CL may include a pixel driving circuit portion (e.g., the pixel driving circuit portion PXC of FIG. 4) and a sensor driving circuit portion (e.g., the sensor driving circuit portion FXC of FIG. 4). For example, as illustrated in FIG. 6, the circuit layer DP_CL may include a fourth pixel transistor T4, a sixth pixel transistor T6, a second sensor transistor ST2, and a third sensor transistor ST3. In an embodiment, the fourth pixel transistor T4 corresponds to the fourth pixel transistor T4 of FIG. 4, the sixth pixel transistor T6 corresponds to the sixth pixel transistor T6 of FIG. 4, the second sensor transistor ST2 corresponds to the second sensor transistor ST2 of FIG. 4, and the third sensor transistor ST3 may correspond to the third sensor transistor ST3 of FIG. 4, but this disclosure is not limited thereto. The fourth pixel transistor T4 may be a transistor included in the second pixel driving circuit portion PXCb, and the sixth pixel transistor T6 may be a transistor included in the third pixel driving circuit portion PXCc, but this disclosure is not limited thereto.

The fourth pixel transistor T4 may include a first contact electrode SE1, a first gate electrode GE1, a first active pattern ACT1, a first lower metal pattern BML1, and a second contact electrode DE1. The sixth pixel transistor T6 may include a third contact electrode SE2, a fourth contact electrode DE2, a second gate electrode GE2, a second active pattern ACT2, and a second lower metal pattern BML2. The second sensor transistor ST2 may include a fifth contact electrode SE3, a third gate electrode GE3, a third active pattern ACT3, a third lower metal pattern BML3, and a sixth contact electrode DE3. The third sensor transistor ST3 may include a seventh contact electrode SE4, a fourth gate electrode GE4, a fourth active pattern ACT4, a fourth lower metal pattern BML4, and an eighth contact electrode DE4.

The circuit layer DP_CL may further include a plurality of insulating layers. For example, the circuit layer DP_CL may further include a first insulating layer IL1, a second insulating layer IL2, a third insulating layer IL3, a fourth insulating layer IL4, a fifth insulating layer IL5, a sixth insulating layer IL6, a seventh insulating layer IL7, an eighth insulating layer IL8, a first gate insulating layer GI1, a second gate insulating layer GI2, a third gate insulating layer GI3, and a fourth gate insulating layer GI4. In addition, the circuit layer DP_CL may further include a first connection electrode CNE1, a second connection electrode CNE2, and a first voltage pattern VLE1.

The first insulating layer IL1 may be located on the substrate SUB. The first insulating layer IL1 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The first lower metal pattern BML1 and the second lower metal pattern BML2 may be located on the first insulating layer IL1. The first lower metal pattern BML1 and the second lower metal pattern BML2 may be spaced apart from each other in a plan view. For example, as illustrated in FIG. 6, the second lower metal pattern BML2 may be spaced apart from the first lower metal pattern BML1 in the second direction DR2. For example, each of the first lower metal pattern BML1 and the second lower metal pattern BML2 may include a metal, an alloy, a metal nitride, a conductive metal oxide, a transparent conductive material, and/or the like. These and comparable materials may be used alone or in combination with each other. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other. The first lower metal pattern BML1 and the second lower metal pattern BML2 may include substantially a same material, and may be formed through a substantially same process.

The second insulating layer IL2 may be located on the first insulating layer IL1. The second insulating layer IL2 may cover the first lower metal pattern BML1 and the second lower metal pattern BML2. The second insulating layer IL2 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The first active pattern ACT1 and the second active pattern ACT2 may be located on the second insulating layer IL2. The first active pattern ACT1 and the second active pattern ACT2 may be spaced apart from each other in a plan view. For example, as illustrated in FIG. 6, the second active pattern ACT2 may be spaced apart from the first active pattern ACT1 in the second direction DR2. Each of the first active pattern ACT1 and the second active pattern ACT2 may include an inorganic semiconductor (e.g., amorphous silicon, polysilicon, a metal oxide semiconductor,), an organic semiconductor, and/or the like. These and comparable materials may be used alone or in combination with each other. The metal oxide semiconductor may include a binary compound (“ABₓ”), a ternary compound (“ABₓC_{y}”), a quaternary compound (“ABₓC_{y}D_{z}”), and/or the like including indium (“In”), zinc (“Zn”), gallium (“Ga”), tin (“Sn”), titanium (“Ti”), aluminum (“Al”), hafnium (“Hf”), zirconium (“Zr”), magnesium (“Mg”), and/or the like. These and comparable materials may be used alone or in combination with each other. For example, the metal oxide semiconductor may include zinc oxide (“ZnOₓ”), gallium oxide (“GaOₓ”), tin oxide (“SnOₓ”), indium oxide (“InOₓ”), indium gallium oxide (“IGO”), indium zinc oxide (“IZO”), indium tin oxide (“ITO”), indium zinc tin oxide (“IZTO”), and indium gallium zinc oxide (“IGZO”). These and comparable materials may be used alone or in combination with each other. In an embodiment, each of the first active pattern ACT1 and the second active pattern ACT2 may include a metal oxide semiconductor. The first active pattern ACT1 and the second active pattern ACT2 may include substantially a same material as each other, and may be formed through a substantially same process.

Each of the first active pattern ACT1 and the second active pattern ACT2 may include a first contact area, a second contact area, and a channel area located between the first contact area and the second contact area. The first contact area of the first active pattern ACT1 and the second contact area of the first active pattern ACT1 may have higher conductivity than the channel area of the first active pattern ACT1. In addition, the first contact area of the second active pattern ACT2 and the second contact area of the second active pattern ACT2 may have higher conductivity than the channel area of the second active pattern ACT2.

The first gate insulating layer GI1 may be located on the first active pattern ACT1. The first gate insulating layer GI1 may at least partially overlap the first active pattern ACT1 in a plan view. The first gate insulating layer GI1 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The first gate electrode GE1 may be located on the first gate insulating layer GI1. The first gate electrode GE1 may at least partially overlap the first gate insulating layer GI1 in a plan view. In addition, the first gate electrode GE1 may at least partially overlap the first active pattern ACT1 in a plan view. For example, the first gate electrode GE1 may overlap the channel area of the first active pattern ACT1 in a plan view. For example, the first gate electrode GE1 may include a metal, an alloy, a metal nitride, a conductive metal oxide, a transparent conductive material, and/or the like. These and comparable materials may be used alone or in combination with each other. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other.

The second gate insulating layer GI2 may be located on the second active pattern ACT2. The second gate insulating layer G2 may at least partially overlap the second active pattern ACT2 in a plan view. For example, the second gate insulating layer GI2 and the first gate insulating layer GI1 may include substantially a same material as each other, and may be formed through substantially the same process to each other.

The second gate electrode GE2 may be located on the second gate insulating layer GI2. The second gate electrode GE2 may at least partially overlap the second gate insulating layer GI2 in a plan view. In addition, the second gate electrode GE2 may at least partially overlap the second active pattern ACT2 in a plan view. For example, the second gate electrode GE2 may overlap the channel area of the second active pattern ACT2 in a plan view. The second gate electrode GE2 and the first gate electrode GE1 include substantially a same material as each other, and may be formed through substantially the same process as each other.

The third insulating layer IL3 may be located on the second insulating layer IL2. The third insulating layer IL3 may cover the first active pattern ACT1, the second active pattern ACT2, the first gate insulating layer GI1, the second gate insulating layer GI2, the first gate electrode GE1, and the second gate electrode GE2. For example, the third insulating layer IL3 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The first contact electrode SE1, the second contact electrode DE1, the third contact electrode SE2 and the fourth contact electrode DE2 may be located on the third insulating layer IL3. The first contact electrode SE1, the second contact electrode DE1, the third contact electrode SE2 and the fourth contact electrode DE2 may be spaced apart from each other in a plan view. For example, as illustrated in FIG. 6, the second contact electrode DE1 may be spaced apart from the first contact electrode SE1 in the second direction DR2, the third contact electrode SE2 may be spaced apart from the second contact electrode DE1 in the second direction DR2, and the fourth contact electrode DE2 may be spaced apart from the third contact electrode SE2 in the second direction DR2. The first contact electrode SE1 may be connected to the first contact area of the first active pattern ACT1 through a contact hole penetrating (or, defining through) the third insulating layer IL3. The second contact electrode DE1 may be connected to the first gate electrode GE1 through a contact hole penetrating (or, defining through) the third insulating layer IL3. The second contact electrode DE1 may be connected to the first lower metal pattern BML1 through a contact hole penetrating (or, defining through) the second insulating layer IL2 and the third insulating layer IL3. The third contact electrode SE2 may be connected to the second lower metal pattern BML2 through a contact hole penetrating (or, defining through) the second insulating layer IL2 and the third insulating layer IL3. The third contact electrode SE2 may be connected to the first contact area of the second active pattern ACT2 through a contact hole penetrating (or, defining through) the third insulating layer IL3. The fourth contact electrode DE2 may be connected to the second contact area of the second active pattern ACT2 through a contact hole penetrating (or, defining through) the third insulating layer IL3. For example, each of the first contact electrode SE1, the second contact electrode DE1, the third contact electrode SE2 and the fourth contact electrode DE2 may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other. The first contact electrode SE1, the second contact electrode DE1, the third contact electrode SE2, and the fourth contact electrode DE2 may include substantially a same material as each other, and may be formed through substantially a same process as each other.

The fourth insulating layer IL4 may be located on the third insulating layer IL3. The fourth insulating layer IL4 may cover the first contact electrode SE1, the second contact electrode DE1, the third contact electrode SE2 and the fourth contact electrode DE2. For example, the fourth insulating layer IL2 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The third lower metal pattern BML3 and the fourth lower metal pattern BML4 may be located on the fourth insulating layer IL4. The third lower metal pattern BML3 and the fourth lower metal pattern BML4 may be spaced apart from each other in a plan view. For example, as illustrated in FIG. 6, the fourth lower metal pattern BML4 may be spaced apart from the third lower metal pattern BML3 in the second direction DR2. For example, each of the third lower metal pattern BML3 and the fourth lower metal pattern BML4 may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other. The third lower metal pattern BML3 and the fourth lower metal pattern BML4 may include substantially a same material as each other, and may be formed through substantially a same process as each other.

The fifth insulating layer IL5 may be located on the fourth insulating layer IL4. The fifth insulating layer IL5 may cover the third lower metal pattern BML3 and the fourth lower metal pattern BML4. For example, the fifth insulating layer IL5 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The third active pattern ACT3 and the fourth active pattern ACT4 may be located on the fifth insulating layer IL5. The third active pattern ACT3 and the fourth active pattern ACT4 may be spaced apart from each other in a plan view. For example, as illustrated in FIG. 6, the fourth active pattern ACT4 may be spaced apart from the third active pattern ACT3 in the second direction DR2. Each of the third active pattern ACT3 and the fourth active pattern ACT4 may include an inorganic semiconductor (e.g., amorphous silicon, polysilicon, a metal oxide semiconductor,), an organic semiconductor, and/or the like. These and comparable materials may be used alone or in combination with each other. The metal oxide semiconductor may include a binary compound (“ABₓ”), a ternary compound (“ABₓC_{y}”), a quaternary compound (“ABₓC_{y}D_{z}”), and/or the like including indium (“In”), zinc (“Zn”), gallium (“Ga”), tin (“Sn”), titanium (“Ti”), aluminum (“Al”), hafnium (“Hf”), zirconium (“Zr”), magnesium (“Mg”), and/or the like. These and comparable materials may be used alone or in combination with each other. For example, the metal oxide semiconductor may include zinc oxide (“ZnOₓ”), gallium oxide (“GaOₓ”), tin oxide (“SnOₓ”), indium oxide (“InOₓ”), indium gallium oxide (“IGO”), indium zinc oxide (“IZO”), indium tin oxide (“ITO”), indium zinc tin oxide (“IZTO”), and indium gallium zinc oxide (“IGZO”). These and comparable materials may be used alone or in combination with each other. In an embodiment, each of the third active pattern ACT3 and the fourth active pattern ACT4 may include a metal oxide semiconductor. The third active pattern ACT3 and the fourth active pattern ACT4 may include substantially a same material as each other, and may be formed through substantially a same process as each other.

Each of the third active pattern ACT3 and the fourth active pattern ACT4 may include a first contact area, a second contact area, and a channel area located between the first contact area and the second contact area. The first contact area of the third active pattern ACT3 and the second contact area of the third active pattern ACT3 may have higher conductivity than the channel area of the third active pattern ACT3. In addition, the first contact area of the fourth active pattern ACT4 and the second contact area of the fourth active pattern ACT4 may have higher conductivity than the channel area of the fourth active pattern ACT4.

The third gate insulating layer GI3 may be located on the third active pattern ACT3. The third gate insulating layer GI3 may at least partially overlap the third active pattern ACT3 in a plan view. For example, the third gate insulating layer GI3 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The third gate electrode GE3 may be located on the third gate insulating layer GI3. The third gate electrode GE3 may at least partially overlap the third gate insulating layer GI3 in a plan view. In addition, the third gate electrode GE3 may at least partially overlap the third active pattern ACT3 in a plan view. For example, the third gate electrode GE3 may overlap the channel area of the third active pattern ACT3 in a plan view. For example, the third gate electrode GE3 may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other.

The fourth gate insulating layer GI4 may be located on the fourth active pattern ACT4. The fourth gate insulating layer G4 may at least partially overlap the fourth active pattern ACT4 in a plan view. For example, the fourth gate insulating layer GI4 and the third gate insulating layer GI3 may include substantially a same material as each other, and may be formed through substantially a same process as each other.

The fourth gate electrode GE4 may be located on the fourth gate insulating layer GI4. The fourth gate electrode GE4 may at least partially overlap the fourth gate insulating layer GI4 in a plan view. In addition, the fourth gate electrode GE4 may at least partially overlap the fourth active pattern ACT4 in a plan view. For example, the fourth gate electrode GE4 may overlap the channel area of the fourth active pattern ACT4 in a plan view. The fourth gate electrode GE4 and the third gate electrode GE3 include substantially a same material as each other, and may be formed through substantially a same process as each other.

The sixth insulating layer IL6 may be located on the fifth insulating layer IL5. The sixth insulating layer IL6 may cover the third active pattern ACT3, the fourth active pattern ACT4, the third gate insulating layer GI3, the third gate electrode GE3, and the fourth gate electrode GE4. For example, the sixth insulating layer IL6 may include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The fifth contact electrode SE3, the sixth contact electrode DE3, the seventh contact electrode SE4, the eighth contact electrode DE4 and the first connection electrode CNE1 may be located on the sixth insulating layer IL6. The fifth contact electrode SE3, the sixth contact electrode DE3, the seventh contact electrode SE4, the eighth contact electrode DE4 and the first connection electrode CNE1 may be spaced apart from each other in a plan view. For example, as illustrated in FIG. 6, the sixth contact electrode DE3 may be spaced apart from the fifth contact electrode SE3 in the second direction DR2, the seventh contact electrode SE4 may be spaced apart from the sixth contact electrode DE3 in the second direction DR2, the eighth contact electrode DE4 may be spaced apart from the seventh contact electrode SE4 in the second direction DR2, and the first connection electrode CNE1 may be spaced apart from the eighth contact electrode DE4 in the second direction DR2. The fifth contact electrode SE3 may be connected to the first contact electrode SE1 through a contact hole penetrating (or, defining through) the fifth insulating layer IL5 and the sixth insulating layer IL6. The fifth contact electrode SE3 may be connected to the first contact area of the third active pattern ACT3 through a contact hole penetrating (or, defining through) the sixth insulating layer IL6. The sixth contact electrode DE3 may be connected to the third gate electrode GE3 through a contact hole penetrating (or, defining through) the sixth insulating layer IL6. The sixth contact electrode DE3 may be connected to the third lower metal pattern BML3 through a contact hole penetrating (or, defining through) the fifth insulating layer IL5 and the sixth insulating layer IL6. The seventh contact electrode SE4 may be connected to the first contact area of the fourth active pattern ACT4 through a contact hole penetrating (or, defining through) the sixth insulating layer IL6. The eighth contact electrode DE4 may be connected to the fourth gate electrode GE4 through a contact hole penetrating (or, defining through) the sixth insulating layer IL6. The eighth contact electrode DE4 may be connected to the fourth lower metal pattern BML4 through a contact hole penetrating (or, defining through) the fifth insulating layer IL5 and the sixth insulating layer IL6. The first connection electrode CNE1 may be connected to the third contact electrode SE2 through a contact hole penetrating (or, defining through) the fourth insulating layer IL4, the fifth insulating layer IL5, and the sixth insulating layer IL6. Each of the fifth contact electrode SE3, the sixth contact electrode DE3, the seventh contact electrode SE4, the eighth contact electrode DE4 and the first connection electrode CNE1 may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other. The fifth contact electrode SE3, the sixth contact electrode DE3, the seventh contact electrode SE4, the eighth contact electrode DE4, and the first connection electrode CNE1 may include substantially a same material as each other, and may be formed through substantially a same process as each other.

The seventh insulating layer IL7 may be located on the sixth insulating layer IL6. The seventh insulating layer IL7 may cover the fifth contact electrode SE3, the sixth contact electrode DE3, the seventh contact electrode SE4, the eighth contact electrode DE4 and the first connection electrode CNE1. In an embodiment, the seventh insulating layer IL7 may include an organic material. For example, the seventh insulating layer IL7 may include phenolic resin, acrylic resin, polyimide resin, polyamide resin, siloxane resin, epoxy resin, and/or the like. These and comparable materials may be used alone or in combination with each other. In an embodiment, the seventh insulating layer IL7 may further include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

The first voltage pattern VLE1 and the second connection electrode CNE2 may be located on the seventh insulating layer IL7. The first voltage pattern VLE1 and the second connection electrode CNE2 may be spaced apart from each other in a plan view. For example, as illustrated in FIG. 6, the second connection electrode CNE2 may be spaced apart from the first voltage pattern VLE1 in the second direction DR2. In an embodiment, the first voltage pattern VLE1 may apply a voltage to the pixel driving circuit portion (e.g., the pixel driving circuit portion PXC of FIG. 4) and the sensor driving circuit portion (e.g., the sensor driving circuit portion FXC of FIG. 4). For example, as illustrated in FIG. 6, the first voltage pattern VLE1 may apply a voltage to the fourth pixel transistor T4 and the second sensor transistor ST2. The first voltage pattern VLE1 may apply one of the first initialization voltage (e.g., the first initialization voltage VINT1 of FIG. 4), the second initialization voltage (e.g., the second initialization voltage VINT2 of FIG. 4), the first power voltage (e.g., the first power voltage ELVDD of FIG. 4), and the second power voltage (e.g., the second power voltage ELVSS of FIG. 4) to the fourth pixel transistor T4 and the second sensor transistor ST2. When the first voltage pattern VLE1 applies the first initialization voltage to the fourth pixel transistor T4 and the second sensor transistor ST2, the first voltage pattern VLE1 may be a portion of the third voltage line (e.g., the third voltage line VL3 of FIG. 4). When the first voltage pattern VLE1 applies the second initialization voltage to the fourth pixel transistor T4 and the second sensor transistor ST2, the first voltage pattern VLE1 may be a portion of the fourth voltage line (e.g., the fourth voltage line VL4 of FIG. 4). When the first voltage pattern VLE1 applies the first power voltage to the fourth pixel transistor T4 and the second sensor transistor ST2, the first voltage pattern VLE1 may be a portion of the first voltage line (e.g., the first voltage line VL1 of FIG. 4). When the first voltage pattern VLE1 applies the second power voltage to the fourth pixel transistor T4 and the second sensor transistor ST2, the first voltage pattern VLE1 may be a portion of the second voltage line (e.g., the second voltage line VL2 of FIG. 4). Each of the first voltage pattern VLE1 and the second connection electrode CNE2 may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other. The first voltage pattern VLE1 and the second connection electrode CNE2 may include substantially a same material as each other, and may be formed through substantially a same process as each other.

The eighth insulating layer IL8 may be located on the seventh insulating layer IL7. The eighth insulating layer IL8 may cover the first voltage pattern VLE1 and the second connection electrode CNE2. In an embodiment, the eighth insulating layer IL8 may include an organic material. For example, the eighth insulating layer IL8 may include phenolic resin, acrylic resin, polyimide resin, polyamide resin, siloxane resin, epoxy resin, and/or the like. These and comparable materials may be used alone or in combination with each other. In an embodiment, the eighth insulating layer IL8 may further include inorganic materials such as silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other.

Referring to FIGS. 4, 5, and 6, in an embodiment, the sensor driving circuit portion FXC may be located on the pixel driving circuit portion PXC. For example, the sensor driving circuit portion FXC may be located on the first pixel driving circuit portion PXCa, the second pixel driving circuit portion PXCb, the third pixel driving circuit portion PXCc, the fourth pixel driving circuit portion PXCd, the fifth pixel driving circuit portion PXCe, and the sixth pixel driving circuit portion PXCf. For example, the transistors ST1, ST2, and ST3 included in the sensor driving circuit portion FXC may be located on the transistors T1, T2, T3, T4, T5, T6, and T7 included in the pixel driving circuit portion PXC. For example, as illustrated in FIG. 6, the second sensor transistor ST2 and the third sensor transistor ST3 may be located on the fourth pixel transistor T4 and the sixth pixel transistor T6. The sensor driving circuit portion FXC is located on the pixel driving circuit portion PXC, and the sensor driving circuit portion FXC may overlap the pixel driving circuit portion PXC in a plan view. If the pixel driving circuit portion PXC and the sensor driving circuit portion FXC are located in a substantially same layer, there might not be enough space for the pixel driving circuit portion PXC and the sensor driving circuit portion FXC. According to an embodiment, as the sensor driving circuit portion FXC is located on the pixel driving circuit portion PXC, a sufficient space for locating the pixel driving circuit portion PXC and the sensor driving circuit portion FXC may be secured. Accordingly, the circuit layer DP_CL suitable for a high-resolution display device may be provided.

Referring back to FIGS. 5 and 6, the element layer DP_LED may be located on the circuit layer DP_CL. The element layer DP_LED may include the light-emitting element (e.g., the light-emitting element LED of FIG. 4) and the light-receiving element OPD. For example, as illustrated in FIG. 6, the element layer DP_LED may include a third light-emitting element LEDc and the light-receiving element OPD. The third light-emitting element LEDc may be located in the third light-emitting area EAc. The third light-emitting element LEDc may include the first electrode E1c, the intermediate layer MLc, and the second electrode E2c. The light-receiving element OPD may be located in the light-receiving area PA. The light-receiving element OPD may include the first sensing electrode O_E1, a light-receiving intermediate layer O_ML, and a second sensing electrode O_E2.

The first sensing electrode O_E1 and the first electrode E1c may be located on the eighth insulating layer IL8. The first sensing electrode O_E1 and the first electrode E1c may be spaced apart from each other in a plan view. For example, the first sensing electrode O_E1 may be located in the light-receiving area PA, and the first electrode E1c may be located in the third light-emitting area EAc. The first sensing electrode O_E1 may be connected to the second sensor transistor ST2 through a contact hole penetrating (or, defining through) the seventh insulating layer IL7 and the eighth insulating layer IL8. For example, the first sensing electrode O_E1 may be connected to the sixth contact electrode DE3 through a contact hole penetrating (or, defining through) the seventh insulating layer IL7 and the eighth insulating IL8. The first electrode E1c may be connected to the sixth pixel transistor T6. In an embodiment, the first electrode E1c may be connected to the third contact electrode SE2 through the first connection electrode CNE1 and the second connection electrode CNE2. For example, the first electrode E1c may be connected to the second connection electrode CNE2 through a contact hole penetrating (or, defining through) the eighth insulating layer IL8, the second connection electrode CNE2 may be connected to the first connection electrode CNE1 through a contact hole penetrating (or, defining through) the seventh insulating layer IL7, and the first connection electrode CNE1 may be connected to the third contact electrode SE2 through a contact hole penetrating or defined through the fourth insulating layer IL4, the fifth insulating layer IL5, and the sixth insulating layer IL6. Each of the first sensing electrode O_E1 and the first electrode E1c may have a stacked structure including ITO/Ag/ITO, but this disclosure is not limited thereto. For example, the first sensing electrode O_E1 may be an anode electrode of the light-receiving element OPD, and the first electrode E1c may be an anode electrode of the third light-emitting element LEDc.

The pixel defining layer PDL may be located on the eighth insulating layer IL8. A light-receiving opening exposing a portion of an upper surface of the first sensing electrode O_E1 may be defined in the pixel defining layer PDL. In addition, a pixel opening exposing a portion of an upper surface of the first electrode E1c may be located in the pixel defining layer PDL. For example, the pixel defining layer PDL may cover a side portion of the first sensing electrode O_E1 and may cover a side portion of the first electrode E1c. For example, the pixel defining layer PDL may include an inorganic material or an organic material. In an embodiment, the pixel defining layer PDL may include an organic material such as an epoxy resin, a siloxane resin, and/or the like. These and comparable materials may be used alone or in combination with each other. In an embodiment, the pixel defining layer PDL may further include a light blocking material including a black pigment, a black dye, and/or the like.

The light-receiving intermediate layer O_ML may be located on the first sensing electrode O_E1. The light-receiving intermediate layer O_ML may be located in the light-receiving opening. For example, the light-receiving intermediate layer O_ML may be located in the light-receiving area PA. The light-receiving intermediate layer O_ML may include a first functional layer, a photoelectric conversion layer located on the first functional layer, and a second functional layer located on the photoelectric conversion layer. For example, the first functional layer may include a hole injection layer, a hole transport layer, and the like, and the second functional layer may include an electron transport layer, an electron injection layer, and the like.

The intermediate layer MLc may be located on the first electrode E1c. The intermediate layer MLc may be located in the pixel opening. For example, the intermediate layer MLc may be located in the third light-emitting area EAc. The intermediate layer MLc may include a first functional layer, a light-emitting layer located on the first functional layer, and a second functional layer located on the light-emitting layer. For example, the first functional layer may include a hole injection layer, a hole transport layer, and the like, and the second functional layer may include an electron transport layer, an electron injection layer, and the like.

The second sensing electrode O_E2 may be located on the light-receiving intermediate layer O_ML. The second sensing electrode O_E2 may be located in the light-receiving area PA. The second sensing electrode O_E2 may be a cathode of the light-receiving element OPD. The second electrode E2c may be located on the intermediate layer MLc. The second electrode E2c may be located in the third light-emitting area EAc. The second electrode E2c may be a cathode of the third light-emitting element LEDc. In an embodiment, the second sensing electrode O_E2 and the second electrode E2c may be connected to each other. For example, one common electrode including the second sensing electrode O_E2 and the second electrode E2c may be located on the pixel defining layer PDL, the light-receiving intermediate layer O_ML, and the intermediate layer MLc. However, this disclosure is not limited thereto, and in an embodiment, the second sensing electrode O_E2 and the second electrode E2c may be separated from each other. For example, each of the second sensing electrode O_E2 and the second electrode E2c may include a metal, an alloy, a metal nitride, a conductive metal oxide, a transparent conductive material, and/or the like. Examples of the metal may include silver (“Ag”), molybdenum (“Mo”), aluminum (“Al”), tungsten (“W”), copper (“Cu”), nickel (“Ni”), chromium (“Cr”), titanium (“Ti”), tantalum (“Ta”), platinum (“Pt”), scandium (“Sc”), and/or the like. These and comparable materials may be used alone or in combination with each other. Examples of the conductive metal oxide may include Indium tin oxide, indium zinc oxide, and/or the like. These and comparable materials may be used alone or in combination with each other. In addition, examples of the metal nitride may include aluminum nitride (“AlNₓ”), tungsten nitride (“WNₓ”), chromium nitride (“CrNₓ”), and/or the like. These and comparable materials may be used alone or in combination with each other.

Although a structure of the third light-emitting element LEDc has been described with reference to FIG. 6, this disclosure is not limited thereto, and the first light-emitting element located in the first light-emitting area EAa, the second light-emitting element located in the second light-emitting area EAb, the fourth light-emitting element located in the fourth light-emitting area EAd, the fifth light-emitting element located in the fifth light-emitting area EAe, and the sixth light-emitting element located in the sixth light-emitting area EAf may have substantially a same structure as the third light-emitting element LEDc.

The encapsulation layer TFE may be located on the device layer DP_LED. The encapsulation layer TFE may be located on the second sensing electrode O_E2 and the second electrode E2c. The encapsulation layer TFE may prevent impurities, moisture, and/or the like from penetrating into the light-receiving device OPD and the third light-emitting element LEDc. For example, the encapsulation layer TFE may include at least one inorganic encapsulation layer and at least one organic encapsulation layer. For example, the inorganic encapsulation layer and the organic encapsulation layer may be alternately stacked. For example, the inorganic encapsulation layer may include silicon oxide (“SiOₓ”), silicon nitride (“SiNₓ”), silicon carbide (“SiCₓ”), silicon oxynitride (“SiOₓN_{y}”), silicon oxycarbide (“SiOₓC_{y}”), and/or the like. These and comparable materials may be used alone or in combination with each other. The organic encapsulation layer may include a cured polymer such as polyacrylate.

The light control layer CFL may be located on the display panel DP. The light control layer CFL may include the black matrix BM, the first color filter CF1, the second color filter CF2, and the overcoating layer OCL.

The black matrix BM may be located on the encapsulation layer TFE. The black matrix BM may define a first opening in the light-receiving area PA. In addition, the black matrix BM may define a second opening in the third light-emitting area EAc.

The first color filter CF1 and the second color filter CF2 may be located on the encapsulation layer TFE. At least a portion of the first color filter CF1 may be located in the first opening of the black matrix BM. For example, the first color filter CF1 may be located in the light-receiving area PA. In an embodiment, the first color filter CF1 may be omitted. At least a portion of the second color filter CF2 may be located in the second opening of the black matrix BM. For example, the second color filter CF2 may be located in the third light-emitting area EAc. The second color filter CF2 may transmit only light having a substantially specific wavelength.

The overcoating layer OCL may be located on the first color filter CF1, the second color filter CF2, and the black matrix BM. The overcoating layer OCL may cover the first color filter CF1, the second color filter CF2, and the black matrix BM.

FIG. 7 illustrates a cross-section of the display device of FIG. 5 taken along line II-II′.

In describing a cross-sectional structure of FIG. 7, substantially duplicate descriptions of components described with reference to FIG. 6 may be omitted. That is, a second voltage pattern VLE2, a first sub-electrode AXE1, a second sub-electrode AXE2, a sub-intermediate layer MLA, and the second pixel transistor T2 will be described in detail with reference to FIG. 7.

Referring to FIG. 7, the second pixel transistor T2 may be located on the substrate SUB. The second pixel transistor T2 may correspond to the second pixel transistor T2 of FIG. 4, but this disclosure is not limited thereto. In addition, the second pixel transistor T2 may be a transistor included in the third pixel driving circuit portion PXCc of FIG. 5, but this disclosure is not limited thereto. The second pixel transistor T2 may include a fifth lower metal pattern BML5, a fifth active pattern ACT5, a fifth gate electrode GE5, a ninth contact electrode SE5, and a tenth contact electrode DE5.

The fifth lower metal pattern BML5 may be located on the first insulating layer IL1. The fifth lower metal pattern BML5 and the first lower metal pattern BML1 of FIG. 6 may include substantially a same material as each other and may be formed through substantially a same process as each other.

The second insulating layer IL2 may cover the fifth lower metal pattern BML5.

The fifth active pattern ACT5 may be located on the second insulating layer IL2. The fifth active pattern ACT5 may include a first contact area, a second contact area, and a channel area located between the first contact area and the second contact area. The fifth active pattern ACT5 and the first active pattern ACT1 of FIG. 6 may include substantially a same material as each other and may be formed through substantially a same process as each other.

The fifth gate insulating layer GI5 may be located on the fifth active pattern ACT5. The fifth gate insulating layer GI5 may at least partially overlap the fifth active pattern ACT5 in a plan view. The fifth gate insulating layer GI5 and the first gate insulating layer GI1 of FIG. 6 may include substantially a same material as each other and may be formed through substantially a same process as each other.

The fifth gate electrode GE5 may be located on the fifth gate insulating layer GI5. The fifth gate electrode GE5 may at least partially overlap the fifth gate insulating layer GI5 in a plan view. In addition, the fifth gate electrode GE5 may overlap the channel area of the fifth active pattern ACT5 in a plan view.

The third insulating layer IL3 may cover the fifth active pattern ACT5, the fifth gate insulating layer GI5, and the fifth gate electrode GE5.

The ninth contact electrode SE5 and the tenth contact electrode DE5 may be located on the third insulating layer IL3. The ninth contact electrode SE5 may be connected to the fifth lower metal pattern BML5 through a contact hole penetrating (or, defining through) the second insulating layer IL2 and the third insulating layer IL3. The ninth contact electrode SE5 may be connected to the first contact area of the fifth active pattern ACT5 through a contact hole penetrating (or, defining through) the third insulating layer IL3. The tenth contact electrode DE5 may be connected to the second contact area of the fifth active pattern ACT5 through a contact hole penetrating (or, defining through) the third insulating layer IL3. The ninth contact electrode SE5, the tenth contact electrode DE5 and the first contact electrode SE1 of FIG. 6 may include substantially a same material as each other and may be formed through substantially a same process as each other.

The fourth insulating layer IL4 may cover the ninth contact electrode SE5 and the tenth contact electrode DE5.

The second voltage pattern VLE2 may be located on the seventh insulating layer IL7. the second power voltage (e.g., the second power voltage ELVSS of FIG. 4) may be applied to the second voltage pattern VLE2. For example, the second voltage pattern VLE2 may be a portion of the second voltage line (e.g., the second voltage line VL2 of FIG. 4). The second voltage pattern VLE2 and the first voltage pattern VLE1 of FIG. 6 may include substantially a same material as each other and may be formed through substantially a same process as each other.

The eighth insulating layer IL8 may cover the second voltage pattern VLE2.

The first sub-electrode AXE1 may be located on the eighth insulating layer IL8. The first sub-electrode AXE1 may be located in the hole area HA. The first sub-electrode AXE1 may be spaced apart from the first electrode E1c in a plan view. For example, as illustrated in FIG. 7, the first sub-electrode AXE1 may be spaced apart from the first electrode E1c in a direction opposite to the second direction DR2. The first sub-electrode AXE1 may be connected to the second voltage pattern VLE2 through a contact hole IL-H penetrating (or, defining through) the eighth insulating layer IL8. The contact hole IL-H may be located in a portion of the hole area HA.

The sub-intermediate layer MLA may be located on the first sub-electrode AXE1. The sub-intermediate layer MLA may at least partially overlap the first sub-electrode AXE1 in a plan view. For example, the sub-intermediate layer MLA may be located in the hole area HA. The sub-intermediate layer MLA may define an opening ML-H. The opening ML-H may be located in a portion of the hole area HA. A portion of an upper surface of the first sub-electrode AXE1 may be exposed through the opening ML-H.

The second sub-electrode AXE2 may be located on the sub-intermediate layer MLA. The second sub-electrode AXE2 may be located in the hole area HA. In an embodiment, the second sub-electrode AXE2 may be connected to the second electrode E2c. For example, one common electrode including the second sub-electrode AXE2 and the second electrode E2c may be located on the pixel defining layer PDL, the sub-intermediate layer MLA, and the intermediate layer MLc. In an embodiment, the second sub-electrode AXE2 may contact the first sub-electrode AXE1. For example, the second sub-electrode AXE2 may contact the first sub-electrode AXE1 through the opening ML-H. Accordingly, a contact portion LD-CNT in which the first sub-electrode AXE1 and the second sub-electrode AXE2 contact each other through the opening ML-H may be defined. The contact portion LD-CNT may be located in the hole area HA. As described above, the first sub-electrode AXE1 may be connected to the second voltage pattern VLE2 through the contact hole IL-H. Accordingly, the second sub-electrode AXE2 may be connected to the second voltage pattern VLE2 to which the second power voltage is applied through the first sub-electrode AXE1. Accordingly, resistance of the common electrode located on the pixel defining layer PDL, the sub-intermediate layer MLA, and the intermediate layer MLc may be reduced. Accordingly, an IR-drop phenomenon of the common electrode may be prevented.

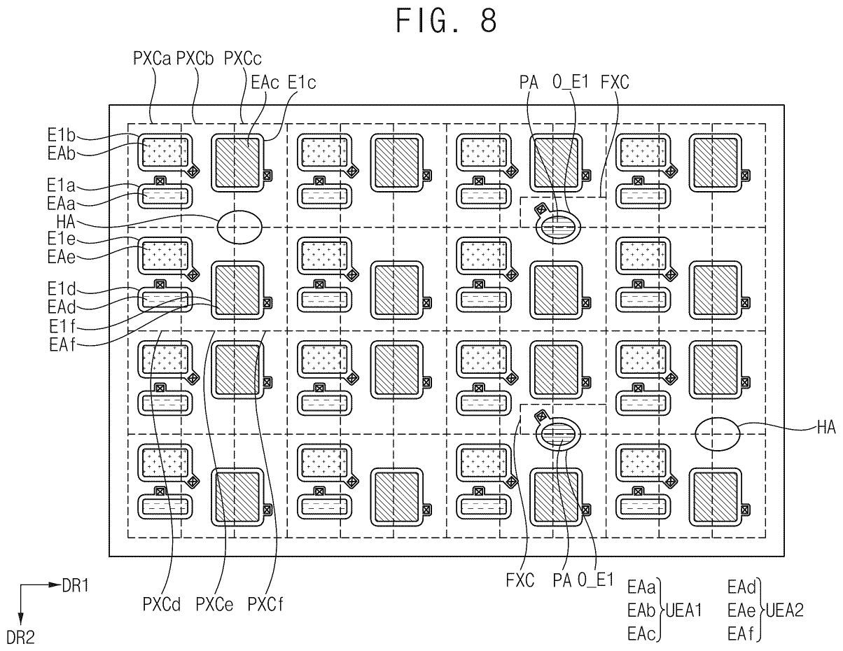

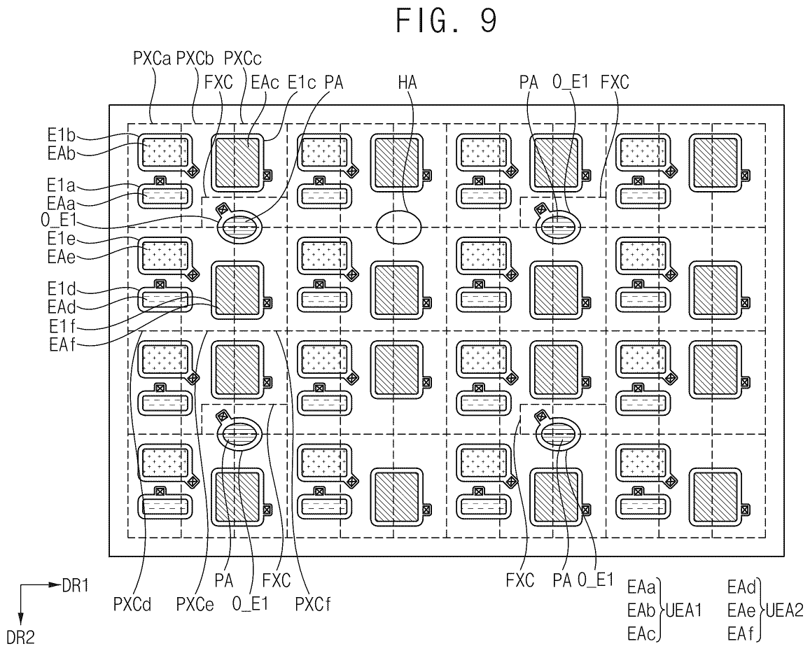

FIG. 8 illustrates a partial area of a display device according to an embodiment. Moreover, FIG. 9 illustrates a partial area of a display device according to an embodiment.

As described above, a position of the hole areas HA of FIG. 5 in a plan view may be variously changed, without limitation thereto. In addition, a position of the light-receiving areas PA of FIG. 5 in a plan view may be variously changed, without limitation thereto. Hereinafter, an example of a position of the hole areas HA in a plan view and a position of the light-receiving areas PA in a plan view will be described. However, a position of the hole areas HA in a plan view and a position of the light-receiving areas PA in a plan view are not limited to those described with reference to FIGS. 8 and 9.

Referring to FIG. 8, the light-receiving area PA may be disposed between the first unit light-emitting area UEA1 disposed in a first row and a third column and the second unit light-emitting area UEA2 disposed in a second row and a third column. The light-receiving area PA may be disposed between the first unit light-emitting area UEA1 disposed in a third row and a third column and the second unit light-emitting area UEA2 disposed in a fourth row and a third column.

Referring to FIG. 9, the light-receiving area PA may be disposed between the first unit light-emitting area UEA1 disposed in a first row and a first column and the second unit light-emitting area UEA2 disposed in a second row and a first column. In addition, the light-receiving area PA may be disposed between the first unit light-emitting area UEA1 disposed in a first row and a third column and the second unit light-emitting area UEA2 disposed in a second row and a third column. In addition, the light-receiving area PA may be disposed between the first unit light-emitting area UEA1 disposed in a third row and a first column and the second unit light-emitting area UEA2 disposed in a fourth row and a first column. In addition, the light-receiving area PA may be disposed between the first unit light-emitting area UEA1 disposed in a third row and a third column and the second unit light-emitting area UEA2 disposed in a fourth row and a third column.

The hole area HA may be disposed between the first unit light-emitting area UEA1 disposed in a first row and a second column and the second unit light-emitting area UEA2 disposed in a second row and a second column.

The display device (e.g., the display device DD of FIG. 1) according to an embodiment may be applied to various electronic devices. An electronic device according to an embodiment may include the above-described display device, and may further include a module or device having other additional functions in addition to the display device.

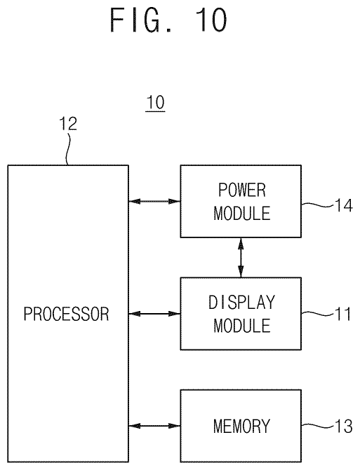

FIG. 10 illustrates an electronic device according to an embodiment.

Referring to FIG. 10, an electronic device 10 according to an embodiment may include a display unit 11, a processor 12, a memory 13, and a power module 14.

The processor 12 may include at least one of a central processing unit (“CPU”), an application processor (“AP”), a graphics processing unit (“GPU”), a communications processor (“CP”), an image signal processor (“ISP”), and/or a controller.

Data information for operation of the processor 12 or the display unit 11 may be stored in the memory 15. When the processor 12 executes an application stored in the memory 15, an image data signal and/or an input control signal is transmitted to the display unit 11, and the display unit 11 may process received signal and output image information through a display screen.

The power module 14 may include a power supply module such as a power adapter or a battery device, and a power conversion module that converts power supplied by the power supply module to generate power required for operation of the electronic device 10.

At least one of the components of the electronic device 10 described above may be included in the display device according to the above-described and/or other embodiments. In addition, some of individual modules functionally included in one module may be included in the display device, and others may be provided separately from the display device. For example, the display device may include the display unit 11, and the processor 12, the memory 13, and the power module 14 may be provided in form of another device in the electronic device 10 other than the display device.

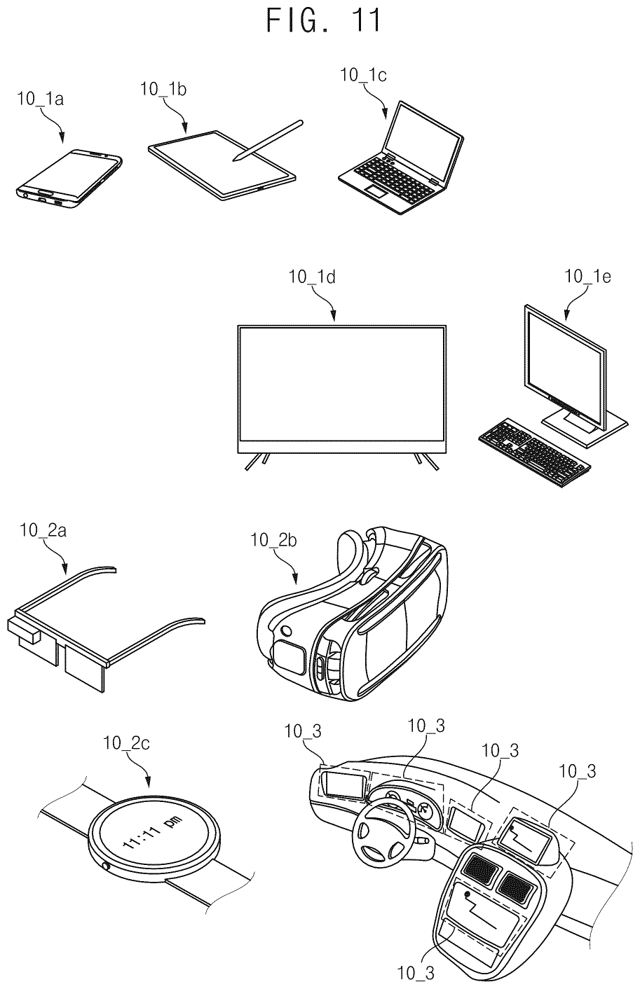

FIG. 11 illustrates an electronic device according to an embodiment.

Referring to FIG. 11, various electronic devices to which display devices according to embodiments may be applied may include not only electronic devices for image display such as a smartphone 10_1a, a tablet PC 10_1b, a laptop 10_1c, a TV 10_1d, a desk monitor 10_1e, and/or the like; but also wearable electronic devices including display modules such as a smart glass 10_2a, a head mounted display 10_2b, a smart watch 10_2c, and/or the like; a vehicle electronic device 10_3 including display modules such as a vehicle's instrument panel, a center fascia, a center information display (“CID”) disposed on a dashboard, a vehicular and/or room mirror display, and/or the like.

The foregoing is illustrative of embodiments and is not to be construed as limiting thereof. Although the present disclosure has been described by way of example, those of ordinary skill in the pertinent art will readily appreciate that many modifications are possible in the described embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A display device comprising:
a pixel driving circuit portion located on a substrate;
a sensor driving circuit portion located on the pixel driving circuit portion;
a light-emitting element electrically connected to the pixel driving circuit portion; and
a light-receiving element electrically connected to the sensor driving circuit portion.

2. The display device of claim 1, wherein the sensor driving circuit portion and the pixel driving circuit portion at least partially overlap each other in a plan view.

3. The display device of claim 1, wherein the pixel driving circuit portion includes a plurality of pixel transistors, and
the sensor driving circuit portion includes a plurality of sensor transistors located on the plurality of pixel transistors.

4. The display device of claim 1, wherein substantially all sensor transistors included in the sensor driving circuit portion are located on pixel transistors included in the pixel driving circuit portion.

5. The display device of claim 1, further comprising:
a voltage line electrically connected to each of the pixel driving circuit portion and the sensor driving circuit portion.

6. The display device of claim 5, wherein the voltage line applies an initialization voltage to each of the pixel driving circuit portion and the sensor driving circuit portion.

7. A display device comprising:
a plurality of first unit light-emitting areas located along a first direction;
a plurality of second unit light-emitting areas located along the first direction and spaced apart from the plurality of first unit light-emitting areas in a second direction crossing the first direction;
a light-receiving area located in at least a portion between the plurality of first unit light-emitting areas and the plurality of second unit light-emitting areas, wherein a light-receiving element is located in the light-receiving area; and
a hole area located in at least a portion between the plurality of first unit light-emitting areas and the plurality of second unit light-emitting areas and spaced apart from the light-receiving area in a plan view, wherein a contact portion where a first sub-electrode and a second sub-electrode contact each other is located in the hole area.

8. The display device of claim 7, wherein the first sub-electrode contacts a voltage pattern to which a power voltage is applied in the hole area.

9. The display device of claim 7, wherein the light-receiving area at least partially overlaps the hole area in the first direction.

10. The display device of claim 7,
wherein each of the plurality of first unit light-emitting areas includes a first light-emitting area emitting a first light, a second light-emitting area emitting a second light, and a third light-emitting area emitting a third light,
wherein each of the plurality of second unit light-emitting areas includes a fourth light-emitting area emitting the first light, a fifth light-emitting area emitting the second light, and a sixth light-emitting area emitting the third light,
wherein the light-receiving area is located between one of the plurality of third light-emitting areas and one of the plurality of sixth light-emitting areas, and
wherein the hole area is located between another one of the plurality of third light-emitting areas and another one of the plurality of sixth light-emitting areas.

11. The display device of claim 10, wherein a distance between the light-receiving area and the one of the plurality of third light-emitting areas adjacent to the light-receiving area and a distance between the hole area and the other one of the plurality of third light-emitting areas adjacent to the hole area are substantially the same.

12. The display device of claim 7, wherein the plurality of first unit light-emitting areas and the plurality of second unit light-emitting areas are alternately located along the second direction.

13. The display device of claim 12, wherein the light-receiving area at least partially overlaps the hole area in the second direction.

14. The display device of claim 7, wherein each of the plurality of first unit light-emitting areas includes a first light-emitting area emitting a first light, a second light-emitting area emitting a second light, and a third light-emitting area emitting a third light,
each of the plurality of second unit light-emitting areas includes a fourth light-emitting area emitting the first light, a fifth light-emitting area emitting the second light, and a sixth light-emitting area emitting the third light, and
a relative position of the third light-emitting area with respect to the first light-emitting area and a relative position of the sixth light-emitting area with respect to the fourth light-emitting area are different from each other.

15. The display device of claim 7, wherein the light-receiving area includes a plurality of light-receiving areas having a substantially constant separation distance from each other.

16. An electronic device comprising:
a pixel driving circuit portion located on a substrate;
a sensor driving circuit portion located on the pixel driving circuit portion;
a light-emitting element electrically connected to the pixel driving circuit portion;
a light-receiving element electrically connected to the sensor driving circuit portion; and
a memory configured to store at least one of pixel data information for the light-emitting element or sensor data information from the light-receiving element.

17. The electronic device of claim 16, wherein the sensor driving circuit portion and the pixel driving circuit portion at least partially overlap each other in a plan view.

18. The electronic device of claim 16, wherein the pixel driving circuit portion includes a plurality of pixel transistors, and
the sensor driving circuit portion includes a plurality of sensor transistors located on the plurality of pixel transistors.

19. The electronic device of claim 16, wherein substantially all sensor transistors included in the sensor driving circuit portion are located on pixel transistors included in the pixel driving circuit portion.

20. The electronic device of claim 16, further comprising:
a plurality of unit light-emitting areas repeatedly located along a first direction and a second direction crossing the first direction, each unit light-emitting area comprising a plurality of light-emitting elements,
a plurality of light-receiving areas repeatedly located between at least some pairs of substantially adjacent unit light-emitting areas, each light-receiving area comprising at least one light-receiving element,
a plurality of hole areas located between at least other pairs of substantially adjacent unit light-emitting areas and spaced apart from each of the plurality of light-receiving areas, each hole area comprising a plurality of contact portions in which a first sub-electrode and a second sub-electrode contact each other.
